(19) United States
(12) Patent Application Publication
(10) Pub. No.: US 2021/0307329 A1
(43) Pub. Date: Oct. 7, 2021

(54) Herbicidal Composition

(71) Applicant: Sumitomo Chemical Australia Pty Ltd, Epping, New South Wales (AU)

(72) Inventor: Christopher van der Hoven, Glenhaven, New South Wales (AU)

(21) Appl. No.: 17/057,903

(22) PCT Filed: May 31, 2019
(86) PCT No.: PCT/AU2019/050553

§ 371 Date: Nov. 23, 2020

(30) Foreign Application Priority Data
May 31, 2018 (AU) 2018901935

(51) Int. Cl. A01N 43/84; A01N 25/26; A01N 25/34

(52) U.S. Cl. CPC A01N 43/84; A01N 25/34; A01N 25/26

(57) ABSTRACT

Herbicide compositions comprising one or more herbicides, an effervescent agent and optionally one or more excipients, wherein the herbicide is preferably one or more protoporphyrinogen oxidase inhibitors are disclosed. Methods of their use in controlling aquatic plants which may be floating, emergent and/or submerged in or on a body of water are also disclosed. Methods of making the herbicide compositions, optionally in discrete solid forms or dissolved in aqueous formulations, are also disclosed.

### CROSS-REFERENCE TO RELATED APPLICATIONS

The present application claims priority from Australian Provisional Patent Application No 2018901935 filed on 31 May 2018, the contents of which are incorporated herein by reference in their entirety.

### TECHNICAL FIELD

Disclosed herein are compositions comprising one or more herbicides, optionally one or more excipients, and methods of their use in controlling plants in or on a body of water. In particular, described herein are compositions which can be formulated to control floating, emergent and/or submerged plants in or on a body of water. The present disclosure also relates to methods of making the compositions and methods of dispersing the compositions, optionally in discrete solid forms, or dissolved in aqueous formulations, to control the plants which may be floating, emergent and/or submerged in or on the body of water.

### BACKGROUND

Aquatic weeds generally fit in three categories based on the way they grow and proliferate. These are floating, emergent or submerged plants. Eradication strategies for aquatic weeds may be determined by their pattern of growth.

There are several herbicides registered and commercially available to control floating weeds. These may be applied with high pressure spray equipment from an elevated vantage point or watercraft to achieve coverage of foliage, which may result in unwanted spray-drift onto non-target flora or sensitive areas.

Emergent weeds require a different approach, depending on the ratio of plant foliage above and below the water line in a body of water. If the majority of leaves and stems are submerged, chemical control by injecting the herbicide into the water column may be successful. Conversely, if the majority of leaves and stems are exposed, there may not be sufficient uptake of the herbicide in the water to give adequate control and application of the herbicide to the foliage is required, often resulting in unwanted spray-drift onto non-target flora or sensitive areas.

Submerged weeds are typically controlled by injecting the herbicide solution into the water column from above using a pressurised sprayer. Alternatively, small pellets or granules are dropped from above into the water, or the herbicide is mixed with Guar gum to weigh it down and provide better coverage of the leaf. There are several limitations to these methods and these include:
Accessibility—submerged weed populations may be very dense and can grow from the bottom of a body water, where they are anchored, right up to the surface. This makes it difficult for watercraft with outboard motors to travel through the weed mass to deliver herbicides.
Applicator safety—Individuals armed with chemical applicators (who apply the herbicide by wading into the body of water) may risk: exposure to the chemicals present in a formulation; entanglement in plants or obstacles; falling victim to local fauna such as crocodiles and alligators; and/or drowning.
Distribution of the chemical—To work effectively, a herbicide should achieve maximum dispersion throughout a treated area, and throughout the water column. Limited access due to weed density and/or limited distribution due to applicator safety concerns mean that not all weeds will receive a fatal dose of the herbicide and re-growth may occur. This is particularly true for herbicide solutions injected from above that rely on a watercraft, from which it is applied, either skimming over and on top of the weeds, or the limited depth to which sub-surface spray nozzles can be inserted before they become entangled in the weed when the watercraft moves forward.
In water bodies where control of aquatic weeds is required and the water bodies contain more than one type of weed. Common combinations of weeds are submerged plus floating weeds e.g., submerged Cabomba with water lily at the surface; and emergent plus floating weeds e.g., Sagittaria with Duckweed on the surface. Treatment may require two separate applications, involving different herbicides and application techniques.
Bodies of water that have become overgrown with aquatic weeds become more stagnant with less than optimal circulation of water. This often creates good breeding conditions for other aquatic organisms e.g., mosquito larvae and/or the body of water may emanate unpleasant odours.

Accordingly, it is desirable to provide a herbicide delivery system that may address one or more shortcomings of the prior art.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

In a first aspect, provided herein is a herbicide composition which controls submerged, emergent and/or floating plants in or on a body of water, the herbicide composition comprising:
a herbicide (for example one or more protoporphyrinogen oxidase inhibitors, such as flumioxazin);
an effervescent agent to disperse the herbicide upon contact of the herbicide composition with the body of water; and
optionally one or more excipients,
   wherein the herbicide composition is formulated to disperse the herbicide:
in a first stage below the surface of the body of water; and
in a second stage at or substantially at the surface of the body of water.

In a second aspect, provided herein is a herbicide composition comprising a herbicide (for example flumioxazin), an effervescent agent and optionally one or more excipients.

In a third aspect, provided herein is an aqueous formulation comprising a herbicide composition according to the first or second aspect.

In a fourth aspect, provided herein is a method of manufacturing a herbicide composition according to the first or second aspect, the method comprising the step of compressing a mixture comprising:
a herbicide (for example one or more protoporphyrinogen oxidase inhibitors, such as flumioxazin);
the effervescent agent; and
optionally one or more excipients.

In a fifth aspect, provided herein is a method for controlling submerged, emergent and/or floating plants in or on a body of water, the method comprising a step of introducing a herbicide composition according to the first or second aspect to the body of water.

In a sixth aspect, provided herein is a method for controlling submerged, emergent and/or floating plants in or on a body of water, the method comprising a step of dissolving the herbicide composition according to the first or second aspect in a composition comprising water and dispersing the resulting product over the submerged, emergent and/or floating plants.

In a seventh aspect, provided herein is the use of a herbicide composition according to the first or second aspect to control submerged, emergent and/or floating plants in or on a body of water.

In an eighth aspect, provided herein is the use of a herbicide composition according to the first aspect or second aspect in the synthesis of an aqueous formulation for dispersing on submerged, emergent and/or floating plants in or on a body of water.

In a ninth aspect, provided herein is the use of an aqueous formulation according to the third aspect, for controlling one or more plants.

In a tenth aspect, provided herein is a method for controlling one or more aquatic plants in or on a body of water, the method comprising a step of introducing a herbicide composition that is capable of dispersing an active ingredient to contact submerged, emergent and/or floating plants following the introduction of the herbicide to the body of water.

In an eleventh aspect, provided herein is use of a herbicide composition that is capable of dispersing an active ingredient to contact submerged, emergent and/or floating plants in or on a body of water, following introduction of the herbicide composition to the body of water

It will be appreciated that the embodiments of each aspect of the present disclosure may equally be applied to each other aspect, mutatis mutandis.

Disclosed herein is a herbicide composition which can be utilised as part of a herbicide delivery system designed to control floating, emergent and/or submerged plants, such as aquatic weeds, in situations, where access to an area of a body of water may be unsafe, unpractical and/or impossible due to the density or location of the target plants which need to be controlled.

In one embodiment the herbicide composition is capable of simultaneously controlling floating, emergent and submerged plants following application to a body of water.

The herbicide composition can be adapted to comprise combinations of herbicides and optionally other active agents, such as pesticides, to control target plants and fauna, such as invertebrate organisms. The herbicides can further comprise compounds for the general enhancement of the target area in the body of water, including but not limited to: the elimination of odour; the enhancement of colour; and/or the improvement of water quality.

Also disclosed herein is a herbicide delivery system capable of delivering a herbicide composition comprising one or more active agents for controlling aquatic plants or aquatic weeds and optionally pests, to a body of water without having to be in direct contact with the body of water. The herbicide delivery system may present a significant improvement to applicator safety by eliminating the needs for application by, for example, boat or watercraft, or for human applicators to enter an area in the body of water which is being treated.

In one embodiment, the herbicide delivery system is capable of providing significant improvements to application efficiency at a target site in or on a body of water.

In another embodiment, the herbicide composition and associated methods, as defined herein, may eliminate or substantially reduce spray-drift onto non-target flora or environmentally sensitive areas in or surrounding a body of water.

In yet another embodiment, the herbicide composition and associated methods defined herein, may eliminate the need for specialised application equipment. In one form, an individual may be able to simply throw, drop or place a discrete solid form of the herbicide composition, e.g., a tablet, into the body of water.

The present disclosure may allow for improved placement and distribution of one or more herbicides (and optionally other active agents) throughout a treated area in a body of water. This may be achieved, for example, by throwing dropping or placing the herbicide composition (for example solid forms of the herbicide composition) into areas of dense vegetation that is otherwise difficult to access by conventional application methods (optionally via hand or the use the mechanical apparatus).

The present disclosure may allow for improved vertical distribution of the pesticide throughout the water column, from the bottom of a body of water right up to the surface. In one embodiment, the herbicide composition is sufficiently heavy and dense enough to penetrate dense foliage and sink to the bottom (or substantially the bottom), of the body of water, from where it starts to release the active materials. This release may be immediate or delayed (for example due to the presence of a water-soluble coating or film applied to or wrapped around the herbicide composition). In one embodiment, accelerated release of the herbicide means that release of a herbicide (and optionally one or more other active agents), occurs as soon as the herbicide composition comes in to contact with water, releasing the herbicide and optional additional active agents upwards in the water column.

In one embodiment, use of a herbicide composition as defined herein allows for the simultaneous control of aquatic weeds or aquatic plants with different growth types, for example control of submerged, emergent and/or floating plants. For example a discrete solid form of the herbicide composition may remain submerged following introduction into a body of water, and continue to release one or more active materials until the herbicide composition has lost a sufficient amount of its original mass and density, at which point is starts to float upwards to release the remaining amount of active agents at or substantially at the surface of the body of water, where one or more active agents may control plants, such as floating plants.

In one form, the herbicide compositions and methods disclosed herein may represent a significant time-saving and productivity improvement compared to prior art.

In one embodiment, use of a herbicide composition as defined herein may prevent over-dosing with one or more active agents, by providing a visible clue of which areas have been treated. For example the herbicide composition may contain a conspicuous dye which appears on the surface above the entry point into the body of water.

The herbicide composition as defined herein, could be used for simultaneous control of aquatic weeds and other unwanted organisms or attributes effects by combining herbicides and optionally other active agents (with different activities and modes of action), or optionally combining herbicides with odour suppressants, dyes, disinfectants and other products used to enhance the general appearance of the body of water to be treated.

### Definitions

With regards to the definitions provided herein, unless stated otherwise, or implicit from context, the defined terms and phrases include the provided meanings. Unless explicitly stated otherwise, or apparent from context, the terms and phrases below do not exclude the meaning that the term or phrase has acquired by a person skilled in the relevant art. The definitions are provided to aid in describing particular embodiments, and are not intended to limit the claimed invention, because the scope of the invention is limited only by the claims. Furthermore, unless otherwise required by context, singular terms shall include pluralities and plural terms shall include the singular.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Throughout this specification, the term “consisting essentially of” is intended to exclude elements which would materially affect the properties of the claimed composition.

The terms “comprising”, “comprise” and “comprises” herein are intended to be optionally substitutable with the terms “consisting essentially of”, “consist essentially of”, “consists essentially of”, “consisting of”, “consist of” and “consists of”, respectively, in every instance.

Throughout the present specification, various aspects and components of the invention can be presented in a range format. The range format is included for convenience and should not be interpreted as an inflexible limitation on the scope of the invention. Accordingly, the description of a range should be considered to have specifically disclosed all the possible sub-ranges as well as individual numerical values within that range, unless specifically indicated. For example, description of a range such as from 1 to 5 should be considered to have specifically disclosed sub-ranges such as from 1 to 3, from 1 to 4, from 1 to 5, from 2 to 4, from 2 to 5, from 3 to 5 etc., as well as individual and partial numbers within the recited range, for example, 1, 2, 3, 4, 5, 5.5 and 6, unless where integers are required or implicit from context. This applies regardless of the breadth of the disclosed range. Where specific values are required, these will be indicated in the specification.

Herein the term “about” encompasses a 10% tolerance in any value(s) connected to the term.

The term “and/or”, e.g., “X and/or Y” shall be understood to mean either “X and Y” or “X or Y” and shall be taken to provide explicit support for both meanings or for either meaning.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean: item A; item A and item B; item B; item A, item B, and item C; or item B and item C. In some cases, “at least one of item A, item B, and item C” may mean, for example and without limitation, two of item A, one of item B, and ten of item C; four of item B and seven of item C; or some other suitable combination.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

Herein “exposure time” refers to the time that a plant is exposed to one or more herbicides present in a herbicide composition as defined herein. Exposure time is arguably important in the sense that, in order to absorb a fatal dose of the active ingredient, a plant should preferably be exposed to a certain minimum concentration for a certain minimum period before the herbicide disperses through currents or through water movement in a body of water. The exposure time will vary from plant species to plant species. In a preferred embodiment the rate of dissolution of the herbicide composition is formulated such that it continues to release the active ingredient for a period that is long enough to give an adequate exposure time. The exposure time may be modified by altering the formulation of the tablet, for example the degree of effervescent loading, the size of the herbicide composition and/or the density of the herbicide composition. The opposite of this is quick release, followed by quick dissolution, which may not be desirable because it reduces exposure time.

Herein “active ingredient” or “active agent”, unless otherwise defined, includes but is not limited to: herbicides, algaecides, pesticides, insecticides, bactericides, fungicides, and mixtures thereof.

Herein submerged, emerging and/or floating plants may be referred to individually or collectively as “weeds” or “aquatic weeds”, “aquatic plants” or “algae”.

Floating plants may be regarded as plants that float on the surface of a body of water, but commonly have some parts submerged e.g., roots, stems and/or bulbs.

Emergent plants are typically anchored in a bottom substrate and have varying percentages of stems and foliage below and above the water line in a body of water.

Submerged plants grow predominantly under the surface of a body of water, but may flower at the surface (because the flowers may need pollinators like bees).

All references or patent applications cited within this patent specification are incorporated by reference herein.

### BRIEF DESCRIPTION OF DRAWINGS

Whilst it will be appreciated that a variety of embodiments of the invention may be utilised, in the following, we describe a number of examples of the invention with reference to the following drawings:

FIG. 1—An exemplified composition comprising flumioxazin in the form of a tablet of approximately 77 mm in diameter. An Australian $2 coin is shown for scale.

FIG. 2—An exemplified composition comprising flumioxazin in the form of a tablet of approximately 28 mm in thickness.

FIG. 3—An exemplified composition comprising flumioxazin in the form of a tablet, in a water soluble sleeve composed of a Type C water soluble material. An Australian $2 coin is shown for scale.

FIG. 4—Illuminated container viewed from the back (image A) and front (image B) for Example 2 and the dissolution study of a herbicide composition comprising flumioxazin.

FIG. 5—Views of the dissolution of an exemplified herbicide composition in a drum in Example 2 at various times (A=0 minutes; B=1 minutes; C=22 minutes; and D=33 minutes).

FIG. 6—Graph showing the weight of an exemplified herbicide composition in Example 2 over time.

FIG. 7—Belmont North site for Trial 1 prior to first application of herbicide composition.

FIG. 8—Eastern Dwarf Tree frog Litoria fallax.

FIG. 9—Photographic record of a trial site before treatment.

FIG. 10—Photographic record of the trial site on Day 5 of Trial 1.

FIG. 11—Photographic record of the trial site on Day 14 of Trial 1.

FIG. 12—Photographic record of the trial site on Day 30 of Trial 1. Circle in image B indicates only remaining Sagittaria.

FIG. 13—Photographic record of the trial site on Day 30 of Trial 1 showing the abundance of the Eastern Dwarf Tree Frogs. The circles image A show the location of the frogs.

FIG. 14—Photographic record of the trial site on Day 45 of Trial 1. The arrow in image C shows Native Water Primrose not affected by the addition of the herbicide.

FIG. 15—Photographic record of the trial site on Day 62 of Trial 1.

FIG. 16—Photographic record of the trial site prior to treatment for Trial 2.

FIG. 17—Photographic record of the trial site on Day 0 of Trial 2. Two circles show where tablets were introduced into the water.

FIG. 18—Photographic record of the trial site on Day 5 of Trial 2.

FIG. 19—Photographic record of the trial site on Day 14 of Trial 2.

FIG. 20—Photographic record of the trial site on Day 30 of Trial 2. Circle in image D shows the presence of exotic carp.

FIG. 21—Photographic record of the trial site on Day 45 of Trial 2.

FIG. 22—Photographic record of the trial site on Day 71 of Trial 2.

### DESCRIPTION OF EMBODIMENTS

### Herbicidal Compositions

Disclosed herein is a herbicide composition formulated such that following introduction to a body of water, the herbicide composition disintegrates and one or more active agents present in said herbicide composition are dispersed into the body of water. Once dispersed, the one or more active agents are able to contact at least one of: submerged plants, emergent plants and floating plants. In one preferred form the herbicide composition is capable of dispersing one or more active ingredients to simultaneously control submerged plants, emergent plants and floating plants.

In one embodiment the herbicide composition comprises one or more protoporphyrinogen oxidase inhibitors.

The herbicide composition may comprise a single herbicide known in the art, for example a protoporphyrinogen oxidase inhibitor (e.g., flumioxazin), or a combination of different herbicides known in the art.

In one embodiment the herbicide composition comprises flumioxazin.

Also disclosed herein is a herbicide composition which controls at least one of submerged, emergent or floating plants in or on a body of water, the herbicide composition comprising:
at least one herbicide;
an effervescent agent to disperse the at least one herbicide upon contact of the herbicide composition with the body of water; and
optionally one or more excipients.

Also disclosed herein is a herbicide composition which controls at least one of submerged, emergent or floating plants in or on a body of water, wherein the herbicide composition is formulated to disperse at least one herbicide:
in a first stage below the surface of the body of water; and
in a second stage at or substantially at the surface of the body of water.

In one embodiment, the herbicide composition displays one or more of the following physical attributes:
the herbicide composition (for example in the form of a tablet) is of sufficient size and/or weight to travel a distance (for example a predetermined distance to a site on the body of water where treatment is required), when thrown from an edge (or near an edge), of a body of water (for example a bank of the body of water to be treated). In a preferred embodiment this negates the need for a boat and/or application equipment, or the need for an individual or party to enter the body of water. For example, an individual can throw the herbicide composition to a site where it is required in the body of water, when the individual is standing on or near an edge of the body of water.
The herbicide composition is of sufficient density to sink to the bottom when it enters the body of water, from where it starts to release one or more herbicides vertically throughout the water column. This may assist, for example, with the control of submerged species like Hydrilla that is anchored in the bottom and grows from a depth.
The herbicide composition rises towards the surface of the body of water following introduction. For example due to the presence of an effervescent, the herbicide composition rises towards the surface the density of the herbicide composition is reduced—thereby also releasing a portion of one or more active ingredients closer to the surface where floating weeds may grow.
That herbicide composition substantially dissolves or preferably completely dissolves and does not leave a concentrated amount of one or more undissolved active ingredients, following administration to a body of water. In another embodiment, the herbicide composition substantially dissolves or preferably completely dissolves and disperses in the body of water.
The herbicide composition dissolves relatively quickly, for example it dissolves in minutes, not hours or days. However, the dissolution time is controlled so it is not too quick, so that any amount of sub-surface current can assist with distribution of the one or more active ingredients as they get released over time.
The herbicide composition comprises a pigment to indicate its position and spatial distribution in the body of water to be treated.

In one embodiment a herbicide composition as defined herein is formulated to control at least one of submerged, emergent and floating plants in at least a portion of a body of water where the herbicide composition is introduced. In another embodiment, a herbicide composition as defined herein is formulated to control at least two of submerged, emergent and floating plants in at least a portion of the body of water where the herbicide composition is introduced. In yet another embodiment, a herbicide composition as defined herein is formulated to simultaneously control submerged, emergent and floating plants in at least a portion of a body of water where the herbicide composition is introduced.

In one embodiment, a herbicide composition as defined herein is introduced to a body of water and has a sufficient weight and/or density to penetrate plants which are present on the surface, or substantially at the surface of the body of water, such that at least a portion of the herbicide composition contacts the body of water. In a preferred embodiment, the herbicide composition is of sufficient density and/or mass to reach the bottom of the body of water.

In one embodiment the herbicide composition is formulated to disperse at least one herbicide (and optionally other active agents) below the surface of a body of water. Herein, this may be referred to as the “first stage”.

During the first stage the herbicide composition is introduced to a portion of the body of water. Once the herbicide composition, or a portion thereof, contacts the water the herbicide composition disintegrates or dissolves, releasing at least one herbicide and possibly additional active agents, such as one or more insecticides, algaecides, fungicides, and/or bactericides into the body of water. During the first stage the dispersal of at least one herbicide (and optionally other active agents), may mean that a larger concentration of at least one herbicide contacts plants present below the surface of the body of water, in relation to any later stages.

In one embodiment the disintegration and dissolution of the herbicide composition is sufficient to disperse at least one herbicide into the body of water such that the at least one herbicide can contact at least one of submerged, emergent and/or floating plants in a region of the body of water where the herbicide composition is introduced.

In another embodiment, as the herbicide composition degrades during the first stage it loses both mass and density. The loss of mass and density may cause the herbicide composition to move substantially vertically through the body of water from an initial starting positon following the introduction of the herbicide composition to the body of water. The movement of the herbicide composition can allow a larger concentration of one or more herbicides, for example flumioxazin, to contact plants at or near the surface of the body of water. The vertical movement of the herbicide composition may be affected by currents present in the body of water and/or by physical contact with an object (e.g., the herbicide composition may be prevented from moving vertically due to a physical barrier such as one or more plants, branches and/or stones).

In one embodiment the herbicide composition is formulated to disperse at least one herbicide (and optionally other active agents) in a substantially vertical column in the first stage, such that at least one herbicide (and optional other active agents) is capable of contacting at least a portion of the submerged, emergent and/or floating plants.

In one embodiment the herbicide composition is formulated to disperse at least one herbicide (and optionally other active agents) at or substantially at the surface of a body of water. Herein, this may be referred to as the “second stage”. In a preferred embodiment the second stage follows dispersal of the at least one herbicide below the surface of the body of water.

In another embodiment, after losing sufficient mass and density, the herbicide composition preferably enters the second stage as defined herein. During the second stage the loss of mass and density may cause the herbicide composition to be present at or substantially at the surface of the body of water. During the second stage the dispersal of at least one herbicide (and optionally other active agents), may mean that a larger concentration of at least one herbicide contacts plants present on, at or substantially at the surface of the body of water, in relation to the first stage.

The presence of an effervescent agent may assist dispersing one or more active agents present in the herbicide composition. The one or more active agents may also be dispersed due to natural currents present in the water or via the introduction of artificial means which stimulate the movement of water in at least a portion of the body of water.

In one scenario, the herbicide composition may become trapped above the surface of the body of water, for example the local flora may be sufficiently dense to support the herbicide composition. The herbicide composition may disintegrate or dissolve due to: the adsorption of water from the atmosphere; the action of rain; and/or an artificial water source delivering water to at least a portion of the herbicide composition.

The herbicide compositions defined herein can be tailored to disperse one or more active agents to at least one of: submerged plants, emergent plants and floating plants. In one embodiment the herbicide composition is formulated so that it is capable of dispersing one or more active agents such that the active agent is able to contact submerged plants, emergent plants and floating plants. For example a herbicide composition can be introduced to a body of water, the density and/or weight of the composition being sufficient to move past any plants above the surface or at or substantially at the surface of the body of water, so that the composition sinks below the surface of the body of water. Once the herbicide composition, or at least a portion thereof, contacts water, the composition can disintegrate or dissolve to release one or more active agents.

The density and/or the weight of the herbicide composition can be tailored to the specific body of water. For example, where a body of water has a high density of plants that need to be treated, the herbicide can be increased in weight and/or density to allow the composition to sink below the surface of the body of water, disintegrate, dissolve or degrade and release one or more active agents into the body of water.

The size, mass and/or density of the herbicide composition can be tailored to control the duration of the first and/or second stage. For example, where a body of water contains a larger proportion of submerged plants with respect to emergent or floating plants, the herbicide composition may be increased in sufficient density, mass and/or effervescent content, so that the first stage is longer, or sufficiently longer, than the second stage.

In a one embodiment the herbicide composition has a density greater than the density of the body of water. The herbicide composition can be added to the body of water, be sufficiently heavy and dense to sink past any plants at or substantially at the surface of the body of water and begin to disintegrate or dissolve below the surface of the body of water, possibly disintegrating or dissolving at the bottom (or substantially the bottom), of the body of water.

The density and/or weight of the herbicide composition may be changed depending on the size of the area that needs to be treated in the body of water and the number and/or type of aquatic plants that need to be treated.

In one embodiment the density and/or weight of the herbicide composition is sufficient such that the herbicide composition initially sinks to the bottom (or substantially the bottom), of the body of water prior to disintegrating, dissolving or degrading and releasing the one or more herbicides (and optionally one or more other active ingredients).

In one embodiment the herbicide composition is formulated with a density of greater than about 1 g cm⁻³. Exemplary ranges and amounts include, but are not limited to: about 1 g cm⁻³ to about 5 g cm⁻³; about 1 g cm⁻³ to about 4 g cm⁻³; about 1 g cm⁻³ to about 3 g cm⁻³; about 1 g cm⁻³ to about 2 g cm⁻³; about 1.1 g cm⁻³ to about 3 g cm⁻³; about 1.2 g cm⁻³ to about 3 g cm⁻³; about 1.3 g cm⁻³ to about 3 g cm⁻³; about 1.4 g cm⁻³ to about 3 g cm⁻³; about 1.5 g cm⁻³ to about 3 g cm⁻³; about 1.6 g cm⁻³ to about 3 g cm⁻³; about 1.7 g cm⁻³ to about 3 g cm⁻³; about 1.8 g cm⁻³ to about 3 g cm⁻³; about 1.9 g cm⁻³ to about 3 g cm⁻³; about 2 g cm⁻³ to about 3 g cm⁻³; about 2.1 g cm⁻³ to about 3 g cm⁻³; about 2.2 g cm⁻³ to about 3 g cm⁻³; about 2.3 g cm⁻³ to about 3 g cm⁻³; about 2.4 g cm⁻³ to about 3 g cm⁻³; about 2.5 g cm⁻³ to about 3 g cm⁻³; about 1.1 g cm⁻³ to about 2 g cm⁻³; about 1.2 g cm⁻³ to about 2 g cm⁻³; about 1.2 g cm⁻³ to about 1.6 g cm⁻³; about 1.3 g cm⁻³ to about 2 g cm⁻³; about 1.4 g cm⁻³ to about 2 g cm⁻³; about 1.5 g cm⁻³ to about 2 g cm⁻³; about 1.6 g cm⁻³ to about 2 g cm⁻³; about 1.7 g cm⁻³ to about 5 g cm⁻³; about 1.8 g cm⁻³ to about 2 g cm⁻³; about 1.9 g cm⁻³ to about 2 g cm⁻³; at least 1 g cm⁻³; at least 1.05 g cm⁻³; at least 1.1 g cm⁻³; at least 1.15 g cm⁻³; at least 1.2 g cm⁻³; at least 1.25 g cm³; at least 1.3 g cm⁻³; at least 1.35 g cm⁻³; at least 1.4 g cm⁻³; at least 1.45 g cm⁻³; at least 1.5 g cm⁻³; at least 1.55 g cm⁻³; at least 1.6 g cm⁻³; at least 1.65 g cm⁻³; at least 1.7 g cm⁻³; at least 1.75 g cm⁻³; at least 1.8 g cm⁻³; at least 1.85 g cm⁻³; at least 1.9 g cm⁻³; at least 1.95 g cm⁻³; or at least 2 g cm⁻³.

In certain situations, for example where the herbicide composition is needed to treat plants on the surface of a body of water, the density of the herbicide composition may be less than about 1 cm⁻³. Exemplary ranges and amounts include, but are not limited to: a range of about 0.5 g cm⁻³ to less than about 1 g cm⁻³; about 0.4 g cm⁻³ to less than about 1 g cm⁻³; 0.45 g cm⁻³ to less than about 1 g cm⁻³; about 0.5 g cm⁻³ to less than about 1 g cm⁻³; about 0.55 g cm⁻³ to less than about 1 g cm⁻³; about 0.6 g cm⁻³ to less than about 1 g cm⁻³; about 0.65 g cm⁻³ to less than about 1 g cm⁻³; about 0.7 g cm⁻³ to less than about 1 g cm⁻³; about 0.75 g cm⁻³ to less than about 1 g cm⁻³; about 0.8 g cm⁻³ to less than about 1 g cm⁻³; about 0.85 g cm⁻³ to less than about 1 g cm⁻³; about 0.9 g cm⁻³ to less than about 1 g cm⁻³; about 0.95 g cm⁻³ to less than about 1 g cm⁻³; about 0.4 g cm⁻³; about 0.45 g cm⁻³; about 0.5 g cm⁻³; about 0.55 g cm⁻³; about 0.6 g cm⁻³ about 0.65 g cm⁻³; about 0.7 g cm⁻³; about 0.75 g cm⁻³; about 0.8 g cm⁻³; about 0.85 g cm⁻³; about 0.9 g cm⁻³; or about 0.95 g cm⁻³.

The herbicide composition may have a mass of at least about 5 g. For example the herbicide composition may have a mass in the range of about 5 g to about 1000 g. Exemplary mass ranges include, but are not limited to: about 5 g to about 1000 g, about 10 g to about 100 g, about 25 g to about 1000 g, about 50 to about 1000 g; about 100 g to about 1000 g; about 150 g to about 1000 g; about 200 g to about 1000 g; about 250 g to about 1000 g; about 300 g to about 1000 g; about 350 g to about 1000 g; about 400 g to about 1000 g; about 450 g to about 1000 g; about 500 g to about 1000 g; about 550 g to about 1000 g; about 600 g to about 1000 g; about 650 g to about 1000 g; about 700 g to about 1000 g; about 750 g to about 1000 g; about 800 g to about 1000 g; about 850 g to about 1000 g; about 900 g to about 1000 g; or about 950 g to about 1000 g; about 60 g to about 800 g; about 60 g to about 700 g; about 60 g to about 600 g; about 60 g to about 600 g; about 60 g to about 500 g; about 60 g to about 400 g; about 60 g to about 300 g; about 60 g to about 200 g. Exemplary masses include, but are not limited to: at least about 5 g, at least about 10 g, at least about 25 g, at least about 50 g; at least about 100 g; at least about 150 g; at least about 200 g; at least about 250 g; at least about 300 g; at least about 350 g; at least about 400 g; at least about 450 g; at least about 500 g; at least about 550 g; at least about 600 g; at least about 650 g; at least about 700 g; at least about 750 g; at least about 800 g; at least about 850 g; at least about 900 g; at least about 950 g; or at least about 1000 g.

The concentration of a herbicide (and optionally other active agents) in the herbicide composition can be tailored to specific conditions, for example: the size and/or condition of the portion of the body of water being treated; the type or amount of aquatic plants in a body of water; and/or the specific efficacy of one or more of the active agents in the herbicide composition.

In one embodiment the herbicide composition comprises one or more active agents (for example one or more active ingredients selected from: herbicides, algaecides, pesticides, insecticides, bactericides, fungicides, and mixtures thereof). In another embodiment one or more of the one or more active ingredients in the herbicide composition may be independently present in the herbicide composition in a range of about 1% w/w to about 90% w/w. Exemplary ranges include but are not limited to: about 1% w/w to about 85% w/w; about 1% w/w to about 80% w/w; about 1% w/w to about 75% w/w; about 1% w/w to about 70% w/w; about 1% w/w to about 65% w/w; about 1% w/w to about 60% w/w; about 1% w/w to about 55% w/w; about 1% w/w to about 50% w/w; about 1% w/w to about 45% w/w; about 1% w/w to about 40% w/w; about 1% w/w to about 35% w/w; about 1% w/w to about 30% w/w; about 1% w/w to about 25% w/w; about 1% w/w to about 20% w/w; about 1% w/w to about 15% w/w; about 1% w/w to about 10% w/w; about 10% w/w to about 90% w/w; about 15% w/w to about 90% w/w; about 20% w/w to about 90% w/w; about 25% w/w to about 90% w/w; about 30% w/w to about 90% w/w; about 35% w/w to about 90% w/w; about 40% w/w to about 90% w/w; about 45% w/w to about 90% w/w; about 50% w/w to about 90% w/w; about 55% w/w to about 90% w/w; about 60% w/w to about 90% w/w; about 65% w/w to about 90 w/w; about 70% w/w to about 90 w/w; about 75% w/w to about 90 w/w, or about 80% w/w to about 90% w/w.

In yet another embodiment one or more of the one or more active ingredients in the herbicide composition (for example one or more active ingredients selected from: herbicides, algaecides, pesticides, insecticides, bactericides, fungicides, and mixtures thereof), may be independently present in the herbicide composition in an amount of: at least about 5% w/w; at least about 10% w/w; at least about 15% w/w; at least about 20% w/w; at least about 25% w/w; at least about 30% w/w; at least about 35% w/w; at least about 40% w/w; at least about 45% w/w; at least about 50% w/w; at least about 55% w/w; at least about 60% w/w; at least about 65% w/w; at least about 70% w/w; at least about 75% w/w; at least about 80% w/w; at least about 85% w/w; or at least about 90% w/w.

In another embodiment the herbicide composition comprises one or more active agents (for example one or more active ingredients selected from: herbicides, algaecides, pesticides, insecticides, bactericides, fungicides, and mixtures thereof), wherein each active agent is independently present in the herbicide composition in an amount of: less than about 5% w/w; less than about 10% w/w; less than about 15% w/w; less than about 20% w/w; less than about 25% w/w; less than about 30% w/w; less than about 35% w/w; less than about 40% w/w; less than about 45% w/w; less than about 50% w/w; less than about 55% w/w; less than about 60% w/w; less than about 65% w/w; less than about 70% w/w; less than about 75% w/w; less than about 80% w/w; less than about 85% w/w; or less than about 90% w/w.

In one embodiment at least one herbicide (for example a protoporphyrinogen oxidase inhibitor, e.g., flumioxazin), is present in the herbicide composition in a range of about 1% w/w to about 80% w/w. Exemplary ranges include but are not limited to: about 1% w/w to about 75% w/w; about 1% w/w to about 70% w/w; about 1% w/w to about 65% w/w; about 1% w/w to about 60% w/w; about 1% w/w to about 55% w/w; about 1% w/w to about 50% w/w; about 1% w/w to about 45% w/w; about 1% w/w to about 40% w/w; about 1% w/w to about 35% w/w; about 1% w/w to about 30% w/w; about 1% w/w to about 25% w/w; about 1% w/w to about 20% w/w; about 1% w/w to about 15% w/w; about 1% w/w to about 10% w/w; about 10% w/w to about 90% w/w; about 15% w/w to about 90% w/w; about 20% w/w to about 90% w/w; about 25% w/w to about 90% w/w; about 30% w/w to about 90% w/w; about 35% w/w to about 90% w/w; about 40% w/w to about 90% w/w; about 45% w/w to about 90% w/w; about 50% w/w to about 90% w/w; about 55% w/w to about 90% w/w; about 60% w/w to about 90% w/w; about 65% w/w to about 90 w/w; about 70% w/w to about 90 w/w; about 75% w/w to about 90 w/w, or about 80% w/w to about 90% w/w.

In another embodiment at least one herbicide (for example a protoporphyrinogen oxidase inhibitor, e.g., flumioxazin), is present in the herbicide composition in an amount of: at least about 1% w/w, at least about 5% w/w; at least about 10% w/w; at least about 15% w/w; at least about 20% w/w; at least about 25% w/w; at least about 30% w/w; at least about 35% w/w; at least about 40% w/w; at least about 45% w/w; at least about 50% w/w; at least about 55% w/w; at least about 60% w/w; at least about 65% w/w; at least about 70% w/w; at least about 75% w/w; at least about 80% w/w; at least about 85% w/w; or at least about 90% w/w.

In another embodiment at least one herbicide (for example a protoporphyrinogen oxidase inhibitor, e.g., flumioxazin), is present in the herbicide composition in an amount of: less than about 5% w/w; less than about 10% w/w; less than about 15% w/w; less than about 20% w/w; less than about 25% w/w; less than about 30% w/w; less than about 35% w/w; less than about 40% w/w; less than about 45% w/w; less than about 50% w/w; less than about 55% w/w; less than about 60% w/w; less than about 65% w/w; less than about 70% w/w; less than about 75% w/w; less than about 80% w/w; less than about 85% w/w; or less than about 90% w/w.

The concentration of one or more active agents can be controlled to tailor the final concentration of the one or more actives in the body of water once the herbicide composition has dissolved or disintegrated. The maximum concentration of a particular active agent may be regulated by local laws in a jurisdiction (e.g., a sovereign nation) or a region (e.g., European Union).

In one embodiment the herbicide composition is formulated such that the final dilution level of at least one active agent present in the herbicide composition is in a range of about 5 parts-per-billion (ppb) to about 1000 parts-per-million (ppm), for example about 5 ppb to about 1 ppm. Exemplary ranges and values include, but are not limited to: about 5 ppb to about 1 ppm; about 10 ppb to about 1 ppm; about 20 ppb to about 1 ppm; about 50 ppb to about 1 ppm; about 100 ppb to about 1 ppm; about 150 ppb to about 1 ppm; about 200 ppb to about 1 ppm; about 250 ppb to about 1 ppm; about 300 ppb to about 1 ppm; about 350 ppb to about 1 ppm; about 400 ppb to about 1 ppm; about 450 ppb to about 1 ppm; about 500 ppb to about 1 ppm; about 550 ppb to about 1 ppm; about 600 ppb to about 1 ppm; about 650 ppb to about 1 ppm; about 700 ppb to about 1 ppm; about 750 ppb to about 1 ppm; about 800 ppb to about 1 ppm; about 850 ppb to about 1 ppm; about 900 ppb to about 1 ppm; or about 950 ppb to about 1 ppm; about 500 ppb to about 600 ppb; about 550 ppb to about 600 ppb; about 250 ppb to about 550 ppb; about 300 ppb to about 550 ppb; about 350 ppb to about 550 ppb; about 350 ppb to about 500 ppb; about 400 ppb to about 500 ppb; about 450 ppb to about 500 ppb; about 400 ppb to about 450 ppb; about 350 ppb to about 450 ppb; about 200 ppb to about 400 ppb; at least about 5 ppb; at least about 10 ppb; at least about 20 ppb; at least about 50 ppb; at least about 100 ppb; at least about 120 ppb; at least about 140 ppb; at least about 160 ppb; at least about 180 ppb; at least about 200 ppb; at least about 220 ppb; at least about 240 ppb; at least about 260 ppb; at least about 280 ppb; at least about 300 ppb; at least about 320 ppb; at least about 340 ppb; at least about 360 ppb; at least about 380 ppb; at least about 400 ppb; at least about 420 ppb; at least about 440 ppb; at least about 460 ppb; at least about 480 ppb; at least about 500 ppb; at least about 520 ppb; at least about 540 ppb; at least about 560 ppb; at least about 580 ppb; at least about 600 ppb; at least about 620 ppb; at least about 640 ppb; at least about 660 ppb; at least about 680 ppb; at least about 700 ppb; at least about 720 ppb; at least about 740 ppb; at least about 760 ppb; at least about 780 ppb; at least about 800 ppb; at least about 820 ppb; at least about 840 ppb; at least about 860 ppb; at least about 880 ppb; at least about 900 ppb; at least about 920 ppb; at least about 940 ppb; at least about 960 ppb; at least about 980 ppb; at least about 1 ppm; at least about 5 ppm; at least about 10 ppm; at least about 20 ppm; at least about 50 ppm; at least about 100 ppm; at least about 120 ppm; at least about 140 ppm; at least about 160 ppm; at least about 180 ppm; at least about 200 ppm; at least about 220 ppm; at least about 240 ppm; at least about 260 ppm; at least about 280 ppm; at least about 300 ppm; at least about 320 ppm; at least about 340 ppm; at least about 360 ppm; at least about 380 ppm; at least about 400 ppm; at least about 420 ppm; at least about 440 ppm; at least about 460 ppm; at least about 480 ppm; at least about 500 ppm; at least about 520 ppm; at least about 540 ppm; at least about 560 ppm; at least about 580 ppm; at least about 600 ppm; at least about 620 ppm; at least about 640 ppm; at least about 660 ppm; at least about 680 ppm; at least about 700 ppm; at least about 720 ppm; at least about 740 ppm; at least about 760 ppm; at least about 780 ppm; at least about 800 ppm; at least about 820 ppm; at least about 840 ppm; at least about 860 ppm; at least about 880 ppm; at least about 900 ppm; at least about 920 ppm; at least about 940 ppm; at least about 960 ppm; at least about 980 ppm; or at least about 1000 ppm.

In one embodiment the herbicide composition is formulated such that the final dilution level of at least one herbicide (for example flumioxazin) in the body of water is in a range of about 5 ppb to about 1000 parts-per-million ppm, for example about 5 ppb to about 1 ppm. Exemplary ranges and values include, but are not limited to: about 5 ppb to about 1 ppm; about 10 ppb to about 1 ppm; about 20 ppb to about 1 ppm; about 50 ppb to about 1 ppm; about 100 ppb to about 1 ppm; about 150 ppb to about 1 ppm; about 200 ppb to about 1 ppm; about 250 ppb to about 1 ppm; about 300 ppb to about 1 ppm; about 350 ppb to about 1 ppm; about 400 ppb to about 1 ppm; about 450 ppb to about 1 ppm; about 500 ppb to about 1 ppm; about 550 ppb to about 1 ppm; about 600 ppb to about 1 ppm; about 650 ppb to about 1 ppm; about 700 ppb to about 1 ppm; about 750 ppb to about 1 ppm; about 800 ppb to about 1 ppm; about 850 ppb to about 1 ppm; about 900 ppb to about 1 ppm; or about 950 ppb to about 1 ppm; about 500 ppb to about 600 ppb; about 550 ppb to about 600 ppb; about 250 ppb to about 550 ppb; about 300 ppb to about 550 ppb; about 350 ppb to about 550 ppb; about 350 ppb to about 500 ppb; about 400 ppb to about 500 ppb; about 450 ppb to about 500 ppb; about 400 ppb to about 450 ppb; about 350 ppb to about 450 ppb; about 200 ppb to about 400 ppb; at least about 5 ppb; at least about 10 ppb; at least about 20 ppb; at least about 50 ppb; at least about 100 ppb; at least about 120 ppb; at least about 140 ppb; at least about 160 ppb; at least about 180 ppb; at least about 200 ppb; at least about 220 ppb; at least about 240 ppb; at least about 260 ppb; at least about 280 ppb; at least about 300 ppb; at least about 320 ppb; at least about 340 ppb; at least about 360 ppb; at least about 380 ppb; at least about 400 ppb; at least about 420 ppb; at least about 440 ppb; at least about 460 ppb; at least about 480 ppb; at least about 500 ppb; at least about 520 ppb; at least about 540 ppb; at least about 560 ppb; at least about 580 ppb; at least about 600 ppb; at least about 620 ppb; at least about 640 ppb; at least about 660 ppb; at least about 680 ppb; at least about 700 ppb; at least about 720 ppb; at least about 740 ppb; at least about 760 ppb; at least about 780 ppb; at least about 800 ppb; at least about 820 ppb; at least about 840 ppb; at least about 860 ppb; at least about 880 ppb; at least about 900 ppb; at least about 920 ppb; at least about 940 ppb; at least about 960 ppb; at least about 980 ppb; at least about 1 ppm; at least about 5 ppm; at least about 10 ppm; at least about 20 ppm; at least about 50 ppm; at least about 100 ppm; at least about 120 ppm; at least about 140 ppm; at least about 160 ppm; at least about 180 ppm; at least about 200 ppm; at least about 220 ppm; at least about 240 ppm; at least about 260 ppm; at least about 280 ppm; at least about 300 ppm; at least about 320 ppm; at least about 340 ppm; at least about 360 ppm; at least about 380 ppm; at least about 400 ppm; at least about 420 ppm; at least about 440 ppm; at least about 460 ppm; at least about 480 ppm; at least about 500 ppm; at least about 520 ppm; at least about 540 ppm; at least about 560 ppm; at least about 580 ppm; at least about 600 ppm; at least about 620 ppm; at least about 640 ppm; at least about 660 ppm; at least about 680 ppm; at least about 700 ppm; at least about 720 ppm; at least about 740 ppm; at least about 760 ppm; at least about 780 ppm; at least about 800 ppm; at least about 820 ppm; at least about 840 ppm; at least about 860 ppm; at least about 880 ppm; at least about 900 ppm; at least about 920 ppm; at least about 940 ppm; at least about 960 ppm; at least about 980 ppm; or at least about 1000 ppm.

In one embodiment the herbicide composition comprises one or more herbicides. For example, the herbicide composition may comprise 1, 2 or 3 herbicides. Different combinations of herbicides may be used in order to increase the efficacy of the overall herbicide composition, or to control different types of aquatic plants in a region of a body of water. The number and type of herbicides can be tailored depending on the concentration and/or type of aquatic plants present in the region of the body of water.

Herbicides that may be present in the herbicide composition, and/or employed in conjunction with the compositions and methods described herein include, but are not limited to: acid, salt, choline salt, ester and optically active isomer forms of the following herbicides: a protoporphyrinogen oxidase inhibitor, calcium dodecyl benzene sulphonate, 4-CPA, 4-CPB, 4-CPP, 3,4-DA, 2,4-D, 2,4-D choline salt, 2,4-DB, 2,2 DPA, 3,4-DB, 3,4-DP, 2,3,6-TBA, 2,4,5-T, 2,4,5-TB, acetochlor, acifluorfen, aclonifen, acrolein, alachlor, allidochlor, alloxydim, allyl alcohol, alorac, ametridione, ametryn, amibuzin, amicarbazone, amidosulfuron, aminocyclopyrachlor, aminopyralid, amiprofos-methyl, amitrole, ammonium sulfamate, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron-methyl, bensulide, bentazon, benthiocarb, benzadox, benzfendizone, benzipram, benzobicyclon, benzofenap, benzofluor, benzoylprop, benzthiazuron, bicyclopyrone, bifenox, bilanafos, bispyribac-sodium, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole, chlorprocarb, carfentrazone (e.g., carfentrazone-ethyl), CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, chlorthiamid, cinidon (e.g., cinidon-ethyl), cinmethylin, cinosulfuron, cisanilide, clethodim, cliodinate, clodinafop-propargyl, clofop, clomazone, clomeprop, cloprop, cloproxydim, clopyralid, cloransulam-methyl, CMA, CPMF, CPPC, credazine, cresol, cumyluron, cyanatryn, cyanazine, cycloate, cyclopyrimorate, cyclosulfamuron, cycloxydim, cycluron, cyhalofop (e.g., cyhalofop-butyl), cyperquat, cyprazine, cyprazole, cypromid, daimuron, dalapon, dazomet, delachlor, desmedipham, desmetryn, di-allate, dicamba, dichlobenil, dichloralurea, dichlormate, dichlorprop, dichlorprop-P, diclofop-methyl, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, disul, dithiopyr, diuron, DMPA, DNOC, DSMA, EBEP, eglinazine, epronaz, EPTC, erbon, esprocarb, ethbenzamide, ethalfluralin, ethametsulfuron, ethidimuron, ethiolate, ethobenzamid, etobenzamid, ethofumesate, ethoxyfen, ethoxysulfuron, etinofen, etnipromid, etobenzanid, EXD, fenasulam, fenoprop, fenoxaprop (e.g., fenoxaprop-P-ethyl), fenoxaprop-P-ethyl+isoxadifen-ethyl, fenoxasulfone, fenquinotrione, fenteracol, fenthiaprop, fentrazamide, fenuron, ferrous sulfate, flamprop, flamprop-M, flazasulfuron, florasulam, fluazifop (e.g., fluazifop-P-butyl), fluazolate, flucarbazone, flucetosulfuron, fluchloralin, flufenacet, flufenican, flufenpyr (e.g., flufenpyr-ethyl), flumetsulam, flumezin, flumiclorac (e.g., flumiclorac-pentyl), flumioxazin, flumipropyn, fluometuron, fluorodifen, fluoroglycofen, fluoromidine, fluoronitrofen, fluothiuron, flupoxam, flupropacil, flupropanate, flupyrsulfuron, flurochloridone, fluroxypyr, flurtamone, fluthiacet, fomesafen, foramsulfuron, fosamine, fumiclorac, furyloxyfen, halosafen, halosulfuron (e.g., halosulfuron-methyl), haloxydine, haloxyfop-methyl, haloxyfop-P (e.g., haloxyfop-P-methyl), hexachloroacetone, hexaflurate, hexazinone, imazamethabenz, imazamox, imazapic, imazapyr, imazaquin, imazosulfuron, indanofan, indaziflam, iodobonil, iodomethane, iodosulfuron, iodosulfuron-ethyl-sodium, iofensulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lancotrione, lenacil, linuron, MAA, MAMA, MCPA esters and amines, MCPA-thioethyl, MCPB, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metobromuron, metolachlor, metosulam, metoxuron, metribuzin, metsulfuron, metsulfuron-methyl, molinate, monalide, monisouron, monochloroacetic acid, monolinuron, monuron, morfamquat, MSMA, naproanilide, napropamide, napropamide-M, naptalam, neburon, nicosulfuron, nipyraclofen, nitralin, nitrofen, nitrofluorfen, norflurazon, noruron, OCH, orbencarb, ortho-dichlorobenzene, orthosulfamuron, oryzalin, oxadiargyl, oxadiazon, oxapyrazon, oxasulfuron, oxaziclomefone, oxyfluorfen, paraflufen-ethyl, parafluron, paraquat, pebulate, pelargonic acid, pendimethalin, penoxsulam, pentachlorophenol, pentanochlor, pentoxazone, perfluidone, pethoxamid, phenisopham, phenmedipham (e.g., phenmedipham-ethyl), phenobenzuron, phenylmercury acetate, picloram, picolinafen, pinoxaden, piperophos, potassium arsenite, potassium azide, potassium cyanate, pretilachlor, primisulfuron (e.g., primisulfuron-methyl), procyazine, prodiamine, profluazol, profluralin, profoxydim, proglinazine, prohexadione-calcium, prometon, prometryn, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen (e.g., pyraflufen-ethyl), pyrasulfotole, pyrazogyl, pyrazolynate, pyrazosulfuron-ethyl, pyrazoxyfen, pyribenzoxim, pyributicarb, pyriclor, pyridafol, pyridate, pyriftalid, pyriminobac, pyrimisulfan, pyrithiobac-sodium, pyroxasulfone, pyroxsulam, quinclorac, quinmerac, quinoclamine, quinonamid, quizalofop, quizalofop-P-ethyl, rhodethanil, rimsulfuron, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosate, sulfosulfuron, sulfuric acid, sulglycapin, swep, TCA, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiazafluron, thiazopyr, thidiazimin, thidiazuron, thiencarbazone-methyl, thifensulfuron, thifensulfuron-methyl, thiobencarb, tiafenacil, tiocarbazil, tioclorim, tolpyralate, topramezone, tralkoxydim, triafamone, tri-allate, triasulfuron, triaziflam, tribenuron (e.g., tribenuron-methyl), tricamba, triclopyr (e.g., triclopyr choline salt), triclopyr esters and salts, tridiphane, trietazine, trifloxysulfuron, trifludimoxazin, trifluralin, triflusulfuron, trifop, trifopsime, trihydroxytriazine, trimeturon, tripropindan, tritac, tritosulfuron, vernolate, xylachlor, and salts, choline salts, esters, optically active isomers and/or mixtures thereof.

The herbicide composition may comprise any herbicide known in the art, including one or more of those described herein. Preferably the herbicide is suitable for administering to a body of water and for the control of one or more aquatic plants which are: submerged in; emerging from; and/or floating on, the body of water. Exemplary herbicides include, but are not limited to: protoporphyrinogen oxidase inhibitors, calcium dodecyl benzene sulphonate, flumioxazin, 2,4-D, acrolein, amine salts of endothall, bifenox, bipyribac sodium, butachlor, carfentrazone-ethyl, chlorfenac, chlorthiamide, copper and chelated copper, copper sulphate, cyanatryn, dicopper dihydroxide carbonate, dichlobenil, dipotassium salts of endothall, diquat, diuron, endothall, fluridone, fluchloralin, glyphosate, hexazinone, hydrogen dioxide, hydrogen peroxide, imazamox, imazapyr, mancozeb, nitrofen, nabam, oxadiazon, metsulfuron, paraquat, penoxulam, pentachorophenol, pendimethalin, pH4062, R24191, simazine, sodium carbonate peroxhydrate, terbutryn, trifludimoxazin, thiram, topramezone, and/or mixtures thereof.

In one embodiment the herbicide composition comprises a protoporphyrinogen oxidase inhibitor.

In one embodiment the herbicide composition comprises at least one protoporphyrinogen oxidase inhibitor selected from the group consisting of: acifluorfen, azafenidin, bifenox, butafenacil, carfentrazone-ethyl, flufenpyr-ethyl, flumiclorac, flumiclorac-pentyl, flumioxazin, fluoroglycofen, fluthiacet-methyl, fomesafen, lactofen, oxadiargyl, oxadiazon, oxyfluorfen, pyraflufen-ethyl, saflufenacil, sulfentrazone and trifludimoxazin, salts and esters thereof, and mixtures thereof. In another embodiment herbicide composition comprises flumioxazin.

In another embodiment the herbicide composition only comprises a single herbicide, for example a protoporphyrinogen oxidase inhibitor. In yet another embodiment the herbicide composition only comprises a single herbicide which is flumioxazin. In yet another embodiment the herbicide comprises a protoporphyrinogen oxidase inhibitor and at least one other herbicide. In yet another embodiment the herbicide comprises flumioxazin and at least one other herbicide. The at least one other herbicide may be a herbicide as described herein. For example, the at least one other herbicide may be selected from: 2,4-D, acrolein, amine salts of endothall, bifenox, bipyribac sodium, butachlor, carfentrazone-ethyl, chlorfenac, chlorthiamide, copper and chelated copper, copper sulphate, cyanatryn, dicopper dihydroxide carbonate, dichlobenil, dipotassium salts of endothall, diquat, diuron, endothall, fluridone, fluchloralin, glyphosate, hexazinone, hydrogen dioxide, hydrogen peroxide, imazamox, imazapyr, mancozeb, nitrofen, nabam, oxadiazon, metsulfuron, paraquat, penoxulam, pentachorophenol, pendimethalin, pH4062, R24191, simazine, sodium carbonate peroxhydrate, terbutryn, thiram, topramezone, and mixtures thereof.

In one embodiment the herbicide composition comprises at least one effervescent agent.

Herein, an “effervescent agent” herein is an agent comprising one or more compounds which, acting together or individually, evolve a gas on contact with water. The evolved gas may be oxygen or carbon dioxide.

In one embodiment the effervescent agent comprises a combination of an acid component and a base component. The acid component and the base component may react in the presence of water to generate carbon dioxide gas.

The acid component can comprise one or more acids and the base component can comprise one or more bases.

In one embodiment the acid component comprises an aliphatic carboxylic acid.

Non limiting examples of the acid component includes, but is not limited to: adipic acid, ascorbic acid, benzoic acid, citric acid, fumaric acid, glutaric acid, lactic acid, lauric acid, malic acid, maleic acid, malonic acid, oxalic acid, phthalic acid, sorbic acid, succinic acid, tartaric acid, ammonium phosphate, potassium bitartrate, potassium phosphate, acid anhydrides of such acids, acid salts of such acids, dipotassium phosphate, disodium pyrophosphate, sodium acid pyrophosphate, sodium phosphate, disodium phosphate, and mixtures thereof.

The base component may be derived from an alkali metal (such as sodium or potassium) or alkaline earth metal (such as calcium or magnesium), or from an ammonium or organo-ammonium group or cation (carbonate derived from a primary, secondary or tertiary amine or from a quaternary ammonium cation). In one embodiment the base component is derived from an alkali metal.

The base component may comprise: a bicarbonate, a carbonate, a sesquicarbonate, or mixtures thereof. For example, the base component may comprise: an alkali metal bicarbonate, an alkaline earth metal bicarbonate, an organic bicarbonate, an alkali metal carbonate, an alkaline earth metal carbonate, an organic carbonate, an alkali metal sesquicarbonate, an alkaline earth metal sesquicarbonate, an organic sesquicarbonate, or a mixture thereof.

Exemplary base components include, but are not limited to: ammonium bicarbonate, calcium bicarbonate, lithium bicarbonate, magnesium bicarbonate, potassium bicarbonate, sodium bicarbonate, arginine carbonate, ammonium carbonate, calcium carbonate, lysine carbonate, potassium magnesium carbonate, sodium carbonate, sodium glycine carbonate, sodium sesquicarbonate, zinc carbonate, or a mixture thereof.

In one embodiment, the effervescent agent comprises an acid component and a base component, wherein the weight ratio of the acid component to the base component is in a range of about 1:5 to about 5:1; exemplary ratios include, but are not limited to: about 1:5 to about 5:1; about 1.5:5 to about 5:1; about 2:5 to about 5:1; about 2.5:5 to about 5:1; about 3:5 to about 5:1; about 3.5:5 to about 5:1; about 4:5 to about 5:1; about 4.5:5 to about 5:1; about 1:5 to about 4.5:1; about 1:5 to about 4:1; about 1:5 to about 3.5:1; about 1:5 to about 3:1; about 1:5 to about 2.5:1; about 1:5 to about 2:1; about 1:5 to about 1.5:1; about 1:2 to about 2:1; about 1.1:1 to about 2:1; about 1.2:1 to about 2:1; about 1.3:1 to about 2:1; about 1.4:1 to about 2:1; about 1.5:1 to about 2:1; about 1.6:1 to about 2:1; about 1.7:1 to about 2:1; about 1.8:1 to about 2:1; about 1.9:1 to about 2:1; about 1:2 to about 1.9:1; about 1:2 to about 1.8:1; about 1:2 to about 1.7:1; about 1:2 to about 1.6:1; about 1:2 to about 1.5:1; about 1:2 to about 1.4:1; about 1:2 to about 1.3:1; about 1:2 to about 1.1:2; about 1:2 to about 1.1:1; about 1:2 to about 1:1.

In an alternative embodiment, the effervescent agent comprises an acid component and a base component, and the ratio of the acid component to the base component is approximately stoichiometric.

In one embodiment an effervescent agent is present in the herbicide composition in a range of about 1% w/w to about 90% w/w. Exemplary ranges include but are not limited to: about 1% w/w to about 85% w/w; about 1% w/w to about 80% w/w; about 1% w/w to about 75% w/w; about 1% w/w to about 70% w/w; about 1% w/w to about 65% w/w; about 1% w/w to about 60% w/w; about 1% w/w to about 55% w/w; about 1% w/w to about 50% w/w; about 1% w/w to about 45% w/w; about 1% w/w to about 40% w/w; about 1% w/w to about 35% w/w; about 1% w/w to about 30% w/w; about 1% w/w to about 25% w/w; about 1% w/w to about 20% w/w; about 1% w/w to about 15% w/w; about 1% w/w to about 10% w/w; about 10% w/w to about 90% w/w; about 15% w/w to about 90% w/w; about 20% w/w to about 90% w/w; about 25% w/w to about 90% w/w; about 30% w/w to about 90% w/w; about 35% w/w to about 90% w/w; about 40% w/w to about 90% w/w; about 45% w/w to about 90% w/w; about 50% w/w to about 90% w/w; about 55% w/w to about 90% w/w; about 60% w/w to about 90% w/w; about 65% w/w to about 90% w/w; about 70% w/w to about 90% w/w; about 75% w/w to about 90% w/w; about 80% w/w to about 90% w/w; or about 85% w/w to about 90% w/w.

In another embodiment an effervescent agent is present in the herbicide composition in an amount of: at least about 5% w/w; at least about 10% w/w; at least about 15% w/w; at least about 20% w/w; at least about 25% w/w; at least about 30% w/w; at least about 35% w/w; at least about 40% w/w; at least about 45% w/w; at least about 50% w/w; at least about 55% w/w; at least about 60% w/w; at least about 65% w/w; at least about 70% w/w; at least about 75% w/w; at least about 80% w/w; or at least about 85% w/w.

In one embodiment an acid component and/or a base component is present in the herbicide composition, wherein the acid component and/or base component are independently present in a range of about 1% w/w to about 90% w/w. Exemplary ranges include but are not limited to: about 1% w/w to about 85% w/w; about 1% w/w to about 80% w/w; about 1% w/w to about 75% w/w; about 1% w/w to about 70% w/w; about 1% w/w to about 65% w/w; about 1% w/w to about 60% w/w; about 1% w/w to about 55% w/w; about 1% w/w to about 50% w/w; about 1% w/w to about 45% w/w; about 1% w/w to about 40% w/w; about 1% w/w to about 35% w/w; about 1% w/w to about 30% w/w; about 1% w/w to about 25% w/w; about 1% w/w to about 20% w/w; about 1% w/w to about 15% w/w; about 1% w/w to about 10% w/w; about 10% w/w to about 90% w/w; about 15% w/w to about 90% w/w; about 20% w/w to about 90% w/w; about 25% w/w to about 90% w/w; about 30% w/w to about 90% w/w; about 35% w/w to about 90% w/w; about 40% w/w to about 90% w/w; about 45% w/w to about 90% w/w; about 50% w/w to about 90% w/w; about 55% w/w to about 90% w/w; about 60% w/w to about 90% w/w; about 65% w/w to about 90% w/w; about 70% w/w to about 90% w/w; about 75% w/w to about 90% w/w; about 80% w/w to about 90% w/w; or about 85% w/w to about 90% w/w.

In another embodiment an acid component and/or a base component is present in the herbicide composition, wherein the acid component and/or base component are independently present in an amount of: at least about 5% w/w; at least about 10% w/w; at least about 15% w/w; at least about 20% w/w; at least about 25% w/w; at least about 30% w/w; at least about 35% w/w; at least about 40% w/w; at least about 45% w/w; at least about 50% w/w; at least about 55% w/w; at least about 60% w/w; at least about 65% w/w; at least about 70% w/w; at least about 75% w/w; at least about 80% w/w; or at least about 85% w/w.

The herbicide composition described herein can be formulated to adapt the exposure time for the one or active agents contained within the herbicide composition.

The herbicidal composition of the present invention is preferably submerged in water for a certain period of time after being introduced into water. The time for the herbicidal composition to be submerged is not particularly limited. The herbicidal composition may be formulated so that it is submerged for, but not limited to: at least about 3 minutes; at least about 5 minutes; at least about 10 minutes; at least about 15 minutes; at least about 20 minutes; at least about 25 minutes; at least about 30 minutes; at least about 35 minutes; at least about 40 minutes; at least about 45 minutes; at least about 50 minutes; at least about 55 minutes; at least about 60 minutes; from about 10 minutes to about 60 minutes; from about 10 minutes to about 50 minutes; from about 10 minutes to about 40 minutes; or from about 10 minutes to about 30 minutes.

The herbicide compositions defined herein may be formulated to have a preferred dissolution time. Herein the “dissolution time” refers to the time taken for the herbicide composition to substantially dissolve in a body of water, preferably to fully dissolve in the body of water.

The exposure time may be only partly affected by the dissolution time. The exposure time may also be affected by other factors such as current or flow rate (for example, in irrigation channels). In a closed pond with no current/circulation, the exposure time may be longer than situations where the same herbicide is introduced to a body of water with a current and/or circulation, regardless of dissolution time because one or more plants remain in contact with the one or more active ingredients contained within the herbicide composition. In an irrigation channel however, dissolution time may need to be reduced because the water “flows” over static weeds and there is limited opportunity for adequate exposure. A person skilled in the art would understand that there are situations where one needs to release the maximum amount of active ingredient(s) into the body of water in the shortest possible time, yielding a short dissolution time.

The dissolution time for the herbicide composition can be tailored to yield a specific dissolution timeframe, for example by varying the concentration of the effervescent agent. In one embodiment the herbicide composition is formulated such that the dissolution time of at least one of the active agents is in a range of about 2 minutes to about 720 minutes. Exemplary dissolution times include ranges of: about 2 minutes to about 720 minutes; about 2 minutes to about 660 minutes; about 2 minutes to about 600 minutes; about 2 minutes to about 540 minutes; about 2 minutes to about 480 minutes; about 2 minutes to about 420 minutes; about 2 minutes to about 360 minutes; about 2 minutes to about 300 minutes; about 2 minutes to about 240 minutes; about 2 minutes to about 180 minutes; about 2 minutes to about 120 minutes; about 2 minutes to about 105 minutes; about 2 minutes to about 90 minutes; about 2 minutes to about 75 minutes; about 2 minutes to about 60 minutes; about 2 minutes to about 45 minutes; about 2 minutes to about 30 minutes; about 2 minutes to about 15 minutes; about 2 minutes to about 10 minutes; or about 2 minutes to about 5 minutes; at least about 2 minutes; at least about 4 minutes; up to about 6 minutes; up to about 8 minutes; up to about 10 minutes; up to about 12 minutes; up to about 14 minutes; up to about 16 minutes; up to about 18 minutes; up to about 20 minutes; up to about 22 minutes; up to about 24 minutes; up to about 26 minutes; up to about 28 minutes; up to about 30 minutes; up to about 60 minutes; up to about 90 minutes; up to about 120 minutes; up to about 150 minutes; up to about 180 minutes; up to about 210 minutes; up to about 240 minutes; up to about 270 minutes; up to about 300 minutes; up to about 330 minutes; up to about 360 minutes; up to about 390 minutes; up to about 420 minutes; up to about 450 minutes; up to about 480 minutes; up to about 510 minutes; up to about 540 minutes; up to about 570 minutes; up to about 600 minutes; up to about 630 minutes; up to about 660 minutes; up to about 690 minutes; or up to about 720 minutes.

In one embodiment the herbicide composition is formulated to have a dissolution time of less than or about: 2, 4, 6, 8, 10, 12, 14, 16, 18, 20, 22, 24, 26, 28, 30, 60, 90, 120, 180 or 240 minutes.

The size of the herbicide composition can be tailored depending on the method used to distribute the herbicide composition in a body of water. For example the herbicide composition may be of an appropriate size to fit in the palm of a human hand.

The herbicide composition may be formed into any shape known in the art, including, but not limited to: round, spherical, cigar-shaped, disk-shaped, cylindrical, and square forms.

The herbicide composition may have a height to diameter ratio in a range of about 1:1 to about 1:8. Exemplary ranges include, but are not limited to: about 1:1 to about 1:7; about 1:1 to about 1:6; about 1:1 to about 1:5; about 1:1 to about 1:4; about 1:1 to about 1:3; about 1:1 to about 1:2; about 1:2 to about 1:8; about 1:3 to about 1:8; about 1:4 to about 1:8; about 1:4 to about 1:8; about 1:5 to about 1:8; about 1:6 to about 1:8; or about 1:7 to about 1:8; at least about 1:1.5; at least about 1:2; at least about 1:2.5; at least about 1:3; at least about 1:3.5; at least about 1:4; at least about 1:4.5; at least about 1:5; about at least 1:5.5; at least about 1:6; at least about 1:6.5; at least about 1:7; at least about 1:7.5; or at least about 1:8.

In one embodiment the herbicide composition has a height to diameter ratio of less than or equal to about 1:10; less than or equal to about 1:9; less than or equal to about 1:8; less than or equal to about 1:7 less than or equal to about 1:6; or less than or equal to about 1:5.

The herbicide composition described herein may take any form known in the art, for example as a solid unit, including discrete solid units. Examples of discrete solid units include tablets, or a composite solid, consisting of multiple discreet units compressed/fused/bound into a single unit. Compressed units may be formed from the compression of one or more of the same or different water dispersible granules.

Characteristics of the herbicide composition, for example: the concentration of one or more active agents; the form (e.g., shape) of the herbicide composition; the density of the herbicide composition; and/or the size of the herbicide composition can be tailored for the body of water being treated and/or the type and concentration of aquatic plants that need to be controlled.

In one embodiment the herbicide composition is in the form of tablet and has a diameter of at least about 20 mm. Exemplary diameters include, but are not limited to: about 20 mm to about 200 mm; about 20 mm to about 150 mm; about 20 mm to about 100 mm; about 30 mm to about 200 mm; about 30 mm to about 150 mm; about 30 mm to about 100 mm; at least about 25 mm; at least about 30 mm; at least about 35 mm; at least about 40 mm; at least about 45 mm; at least about 50 mm; at least about 55 mm; at least about 60 mm; at least about 65 mm; at least about 70 mm; at least about 75 mm; at least about 80 mm; at least about 85 mm; at least about 90 mm; at least about 95 mm; at least about 100 mm; at least about 105 mm; at least about 110 mm; at least about 115 mm; at least about 120 mm; at least about 125 mm; at least about 130 mm; at least about 135 mm; at least about 140 mm; at least about 145 mm; at least about 150 mm; at least about 155 mm; at least about 160 mm; at least about 165 mm; at least about 170 mm; at least about 175 mm; at least about 180 mm; at least about 185 mm; at least about 190 mm; at least about 195 mm; or at least about 200 mm.

Herbicide compositions described herein can further comprise one or more excipients. The term “excipient” herein means any substance, not itself an active agent (such as a herbicide). Excipients may be used as a carrier or vehicle for delivery of one or more active agents in the herbicide composition, or added to a herbicide composition to improve its: handling, compression, binding, storage, stability, disintegration, dispersion, dissolution, and/or release of one or more active agents, and/or to permit or facilitate formation of a dose unit of the herbicide composition into a discrete article such as tablet suitable for distribution in a body of water.

Excipients include, by way of illustration and not limitation, one or more of: a dye, a marker, a pigment, a lubricant, an anti-adherent, a glidant, solid carriers or fillers, diluents, absorbents, surfactants, dispersants (e.g. polycarboxylates, Tersperse® such as Tersperse® 2700), emulsifiers, adjuvants, solubilisers, penetration enhancers, protective colloids, adhesion agents, thickeners, compatibilisers, anti-freezing agents, surface modifying agents, binders, disintegration agents, wetting agents, substances added to mask or counteract a disagreeable odour, substances added to improve appearance of the composition, substances added to improve appearance of the body of water, and mixtures thereof.

Examples of lubricants include, but are not limited to: silica, fumed alumina, and mixtures thereof.

Examples of glidants and/or anti-adherents include, but are not limited to: magnesium stearate, magnesium dodecane, magnesium oxide, PEG, hydrogenated vegetable oils, corn starch, sodium benzoate, a polysorbate, and mixtures thereof.

Examples of fillers include, but are not limited to: silica, silica gels, silicates, talc, kaolin, limestone, lime, chalk, bole, less, clay, dolomite, diatomaceous earth, calcium sulfate, magnesium sulfate, magnesium oxide, ground synthetic materials, pyrophyllite clay, attapulgus clay, kieselguhr, calcium carbonate, bentonite clay, Fuller's earth, cottonseed hulls, wheat flour, soybean flour, pumice, wood flour, walnut shell flour, lignin, ammonium sulfate, ammonium phosphate, ammonium nitrate, ureas, cereal meal, tree bark meal, wood meal and nutshell meal, cellulose powders, and mixtures thereof.

Examples of binders include, but are not limited to: binders which are readily water-soluble to give low viscosity solutions at high binder concentrations, such as polyethyleneglycol (PEG), polyvinylpyrrolidone, polyvinyl alcohol, carboxymethyl cellulose, gum arabic, sugars e.g., sucrose or sorbitol, starch, ethylene-vinyl acetate copolymers, sucrose and alginates, and mixtures thereof.

Examples of diluents, absorbents or carriers include, but are not limited to: carbon black, talc, diatomaceous earth, kaolin, aluminium, calcium or magnesium stearate, sodium tripolyphosphate, sodium tetraborate, sodium sulphate, sodium, aluminium and mixed sodium-aluminium silicates, sodium benzoate, and mixtures thereof.

Examples of disintegration agents include, but are not limited to: surfactants, materials that swell in water, for example carboxy methylcellulose, collodion, polyvinylpyrrolidone and microcrystalline cellulose swelling agents; salts such as sodium or potassium acetate, sodium carbonate, bicarbonate or sesquicarbonate, ammonium sulphate and dipotassium hydrogen phosphate, and mixtures thereof.

Examples of dispersants include, but are not limited to: sulphonated naphthalene formaldehyde condensates and acrylic copolymers such as the comb copolymer having capped polyethylene glycol side chains on a polyacrylic backbone, and mixtures thereof.

Examples of wetting agents include, but are not limited to: alcohol ethoxylate and alcohol ethoxylate/propoxylate wetting agents, sodium diisobutyl sulfosuccinates, and mixtures thereof. Commercial wetting agents include anionic wetting agents, such as Terwet®, including Terwet® 1004.

Examples of emulsifiers include, but are not limited to: alcohol ethoxylates, ABA block copolymers, or castor oil ethoxylates, and mixtures thereof.

In one embodiment the herbicide composition comprises at least one dye or at least one pigment. The presence of a dye and/or pigment can assist one or more parties monitoring the dispersion of one or more active agents present in the herbicide composition. The presence and dispersal of a dye or pigment in a body of water can be indicative of the dissolution and distribution of the one or more active agents in the body of water. The presence of a dye or pigment can therefore assist in monitoring whether one or more herbicides are being distributed in a region of the body of water and whether or not more of the herbicide composition needs to be introduced into the body of water. In a preferred embodiment of the invention, each unit of a herbicide composition as defined herein will contain a dye or pigment to indicate which areas have been treated and to prevent over-dosing or duplication of treatment.

Exemplary dyes or pigments include, but are not limited to: inorganic pigments such as iron oxide, titanium oxide and Prussian blue; organic dyes such as alizarin dye, azo dyes, metal phthalocyanines, Oleum Blue Powder (C.I Acid Blue 9), and mixtures thereof.

The herbicide composition herein may comprise or be encapsulated in a film or the herbicide composition may comprise a coating. For example the herbicide composition herein may comprise or be encapsulated in a water-soluble film, or the herbicide composition may comprise a water-soluble coating. The water-soluble film or water-soluble coating may allow safe handling of the herbicide composition, for example it may create a barrier so that components of the herbicide composition do not come into direct contact with human skin. The presence of a water-soluble coating or film may also be advantageous in the disintegration of a herbicide composition, for example by extending the lifetime of the herbicide composition, wherein the presence of the water-soluble coating or film allows sufficient time for the herbicide composition to settle in a body of water prior to the herbicide composition disintegrating or dissolving and releasing the one or more active agents. Use of a water-soluble film or coating may also prevent the herbicide composition from absorbing water, which may be important when an effervescent agent in present in the herbicide composition.

In one embodiment, each discrete unit of a herbicide composition as defined herein, can be wrapped in film or coating to prevent direct contact with the active or inert ingredients by a user. In a preferred embodiment, the film or coating is water-soluble.

In another embodiment, each discrete unit of a herbicide composition as defined herein, is wrapped in a water-soluble film or water-soluble coating. The water-soluble film or water-soluble coating may dissolve rapidly, preferably with no effect on the body of water being treated or the local environment. For example the water-soluble film or the water-soluble coating may dissolve within: less than about 30 seconds; less than about 1 minute; less than about 1.5 minutes; less than about 2 minutes; less than about 2.5 minutes; less than about 3 minutes; less than about 3.5 minutes; less than about 4 minutes; less than about 4.5 minutes; less than about 5 minutes; less than about 6 minutes; less than about 7 minutes; less than about 8 minutes; less than about 9 minutes; or less than about 10 minutes. In one embodiment the water-soluble film or the water-soluble coating dissolves in less than about 2 minutes.

The water-soluble film or water-soluble coating may be formulated to dissolve within a particular timescale depending on the body of water being treated with the herbicide composition and/or the type of aquatic plants that are being eradicated or controlled in the body of water.

In one embodiment the herbicide composition is encapsulated in a water-soluble film. Such films are known in the art and may be applied using fluidized bed and drum film coating techniques. Alternatively herbicide composition may be inserted into a pre-formed bag comprising or consisting of a water soluble film. In addition packaging machines capable of wrapping the herbicide composition (e.g., when the herbicide is in the form of a tablet) in a water soluble film may be used.

The water-soluble film may be selected from, but not limited to: Type Z films, Type C films, Type W films, and mixtures thereof. Characteristics of water soluble film types are shown in Table 1. In one embodiment the water soluble film dissolves in water which has a temperature of less than or equal to about 25, 15 or 5° C. In a further embodiment the water soluble film is environmentally neutral.

TABLE 1
Characteristics of type Z, C and W films.

| | Cold water soluble film | | |
|---|---|---|---|
| Classification | Type Z | Type C | Type W |
| Dissolving | At least 5° C. | At least 15° C. | At least 25° C. |
| temperature | | | |
| (recommended) | | | |

Examples of water-soluble films may be selected from, but not limited to, films comprising: poly(vinyl alcohol), poly(vinyl acetate) (e.g., Solpak water soluble poly(vinyl acetate) film, such as a Type Z, Type C or Type film), poly(ethylene oxide), poly(N-vinyl pyrrolidone), poly(acrylic acid), poly(methacrylic acid), poly(acrylamide) and copolymers, blends or mixtures thereof. The water-soluble film may comprise cellulose, glycerol, poly(ethylene glycol), citric acid, urea, water, sodium acetate, potassium nitrate, ammonium nitrate, fertilizers, agar, xanthan gum, alginate, hydroxypropylcellulose, methylcellulose, carboxymethylcellulose, poly(acrylic acid), sodium polyacrylate, guar gum, pectin, a water-soluble protein, a water-soluble carbohydrate, gelatin, or sodium carboxymethylcellulose and blends or crosslinked versions thereof, or mixtures thereof.

In another embodiment the herbicide composition comprises or is encapsulated in a water-soluble coating. Examples of water-soluble coatings include, but are not limited to: polyethylene glycol (e.g., with a molecular weight of 1000, 2000, 3000, 4000, or 5000), polyvinyl alcohol, polyvinylpyrrolidone, hydroxymethylcellulose, hydroxypropylcellulose, methylcellulose, and mixtures thereof.

The herbicide composition may comprise at least one active agent which is not a herbicide. Examples of possible additional components include, but are not limited to: an insecticide, an algaecide, a bactericide, fungicide, or a combination thereof.

In one embodiment the herbicide composition comprises at least one insecticide.

Exemplary insecticides include, but are not limited to: acetylcholinesterase inhibitors, GABA-gated chloride channel blockers, sodium channel modulators, nicotinic acetylcholine receptor (nAChR) competitive modulators, nicotinic acetylcholine receptor allosteric modulators (nAChR), glutamate-gated chloride (GluCl) channel allosteric modulators, juvenile hormone mimics, miscellaneous non-specific (multi-site) inhibitors, chordotonal organ TRPV channel modulators, mite growth inhibitors, microbial disrupters of insect midgut membranes, inhibitors of mitochondrial ATP synthase, an uncoupler of oxidative phosphorylation via disruption of the proton gradient, nicotinic acetylcholine receptor channel blockers, inhibitors of chitin biosynthesis type 0 or type 1, moulting disruptor, dipteran, ecdysone receptor agonists, octopamine receptor agonists, mitchondrial complex III electron transport inhibitors, mitchondrial complex I electron transport inhibitors, voltage-dependent sodium channel blockers, inhibitors of acetyl CoA carboxylase, mitochondrial complex IV electron transport inhibitors, mitochondrial complex II electron transport inhibitors, ryanodine receptor modulators, or chordotonal organ modulators with an undefined target site, or a mixture thereof.

In addition, exemplary insecticides also include, but are not limited to carbamates, organophosphates, cyclodiene organochlorines, phenylpyrazoles (fiproles), pyrethroids, pyrethrins, neonicotinoids, nicotine, sulfoximine, spinosyns, avermectins, milbemycins, juvenile hormone analogues, fenoxycarb, pyriproxyfen, alkyl halides, chloropicrin, fluorides, pyridine azomethine derivatives, clofentezine, hexythiazox, etoxazole, Bacillus thuringiensis and the insecticidal proteins they produce, B. sphaericus and the insecticidal proteins they produce, diafenthiuron, organotin miticides, propargite, tetradifon, chlorfenapyr, nereistoxin analogues, benzoylureas, buprofezin, cyromazine, diacylhydrazines, amitraz, hydramethylnon, bifenazate, METI acaricides and insecticides, rotenone, oxadiazines, semicarbazones, tetronic and tetramic acid derivatives, phosphides, cyanides, beta-ketonitrile derivatives, carboxanilides, diamides, flonicamid, azadirachtin, dicofol, lime sulphur, sulphur, and mixtures thereof.

In addition, exemplary insecticides include, but are not limited to: abamectin, acephate, acetamiprid, allethrin, alpha-cypermethrin, aluminium phosphide, amitraz, azadirachtin, azamethiphos, azinphos methyl, Bacillus thuringiensis aizawai, Bacillus thuringiensis israelensis, Bacillus thuringiensis kurstaki, Bacillus sphaericus, Bacillus thuringiensis tenebrionis, bendiocarb, beta-cyfluthrin, bifenazate, bifenthrin, bioallethrin, bioresmethrin, bistrifluron, buprofezin, cadusafos, carbaryl, carbofuran, carbosulfan, chlorantraniliprole, chlorfenvinphos, chlorfluazuron, chlorfenapyr, chloropicrin, chlorpyrifos, chlorpyrifos-methyl, clofentezine, clothianidin, cyantraniliprole, cyfluthrin, cypermethrin, cyromazine, deltamethrin, diafenthiuron, diazinon, dichlorvos, dicofol, diflubenzuron, dimethoate, dinotefuran, emamectin benzoate, esbiothrin, ethion, etoxazole, esfenvalerate, fenamiphos, fenbutatin oxide, fenitrothion, fenoxycarb, fenpyroximate, fenthion, fenvalerate, fipronil, flonicamid, flubendiamide, flufenoxuron, flumethrin, gamma-cyhalothrin, hexaflumuron, hexythiazox, hydramethylnon, imidacloprid, imiprothrin, indoxacarb, lambda-cyhalothrin, lufenuron, magnesium phosphide, maldison (malathion), metaflumizone, methidathion, methiocarb, methomyl, methoprene, methoxyfenozide, methyl bromide, mevinphos, milbemectin, oxamyl, omethoate, permethrin, phorate, phosmet, phosphine, pirimicarb, pirimiphos-methyl, prallethrin, profenofos, propargite, propoxur, prothiofos, pymetrozine, pyrethrins, pyridaben, pyriproxyfen, spinosad, spinetoram, spirotetramat, sulfoxaflor, tau-fluvalinate, tebufenozide, tebufenpyrad, temephos, terbufos, tetradifon, tetramethrin, thiacloprid, thiamethoxam, thiodicarb, transfluthrin, trichlorfon, triflumuron, zeta-cypermethrin, and mixtures thereof.

In one embodiment the herbicide composition comprises at least one algaecide.

Exemplary algaecides include, but are not limited, to: benzalkonium chloride, bethoxazim, copper sulphate, cybutryne, dichlone, dichlorophen, diuron, endothall, fentin, hydrated lime, isoproturon, methabenzthiazuron, nabam, oxyfluorfen, pentachlorophenol laurate, quinoclamine, quinonamid, simazine, terbutryn and tiodonium, and mixtures thereof.

In one embodiment the herbicide composition comprises at least one bactericide.

Exemplary bactericides include, but are not limited to: disinfectants including active chlorine compounds, active oxygen compounds, iodine, concentrated alcohols, phenolic substances, cationic surfactants, strong oxidizers, heavy metals and their salts, strong acids, alkalis above pH 13; antiseptics including chlorine preparations, iodine preparations, peroxides, alcohols, sorbic acid, benzoic acid, lactic acid, salicylic acid, phenolic compounds, and mixtures thereof.

In one embodiment the herbicide composition comprises at least one fungicide.

Exemplary fungicides include, but are not limited to: benalaxyl, benalaxyl M, furalaxyl, metalaxyl, metalaxyl-M, bupirimate, dimethirimol, ethirimol, ametoctradin, octhilinone, oxolinic acid, benomyl, carbendazim, fuberidazole, thiabendazole, thiophanate-methyl, diethofencarb, zoxamide, pencycuron, fluopicolide, diflumetorim, benodanil, flutolanil, mepronil, fenfuram, carboxin, bixafen, fluxapyroxad, furametpyr, isopyrazam, penflufen, penthiopyrad, sedaxane, boscalid, fluopyram, thifluzamide, pyribencarb, fenamidone, famoxadone, azoxystrobin, dimoxystrobin, enestrobin, fluoxastrobin, kresoxim-methyl, metominostrobin, picoxystrobin, pyraclostrobin, pyrametostrobin, pyraoxystrobin, trifloxystrobin, cyazofamid, amisulbrom, fluazinam, binapacryl, dinocap, meptyldinocap, ferimzone, fentin acetate, fentinchloride, fentin hydroxide, silthiofam, cyprodinil, mepanipyrim, pyrimethanil, oxytetracycline, quinoxyfen, fludioxonil, fenpiclonil, vinclozolin, iprodione, procymidone, chlozolinate, isoprothiolane, edifenphos, iprobenfos, pyrazophos, biphenyl, dicloran, quintozene, tecnazene, tolclofos-methyl, etridiazole, chloroneb, iodocarb, prothiocarb, dimethomorph, flumorph, mandipropamid, benthiavalicarb-isopropyl, iprovalicarb, valifenalate, Bacillus subtillis strain QST 713, imazalil, oxpoconazole, pefurazoate, prochloraz, triforine, pyrifenox, fenarimol, nuarimol, azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimefon, triadimenol, triticonazole, aldimorph, dodemorph, fenpropimorph, tridemorph, fenpropidin, piperalin, spiroxamine, fenhexamid, naftifine, terbinafine, fenhexamid, validamycin, phthalide, tricyclazole, diclocymet, carpropamid, fenoxanil, bordeaux mixture, copper hydroxide, copper oxychloride, cupric ammonium carbonate, cuprous oxide, sulphur, cufraneb, ferbam, mancozeb, maneb, propineb, thiram, zineb, ziram, metiram, captafol, captan, folpet, chlorothalonil, dichlofluanid, tolylfluanid, dodine, guazatine, iminoctadine, anilazine, dithianon, acibenzolar-S-methyl, probenazole, flutianil, isotianil, tiadinil, cymoxanil, flusulfamide, metrafenone, pyriofenone, triazoxide, fosetyl-aluminium, cyflufenamid, tecloftalam (bactericide), diclomezine, proquinazid, tebufloquin, ethaboxam and methasulfocarb, and mixtures thereof.

The water content of the herbicide composition may be controlled to prevent premature disintegration of a solid form of the herbicide composition. Controlling the water content may assist in extending the lifetime of the herbicide composition during transit and/or storage, and/or before the herbicide composition is distributed in a body of water.

The herbicide composition may have a water content of less than about 5% w/w. Exemplary values include, but are not limited to: less than about 5% w/w; less than about 4.5% w/w; less than about 4% w/w; less than about 3.5% w/w; less than about 3% w/w; less than about 2.5% w/w; less than about 2% w/w; less than about 1.5% w/w; less than about 1% w/w; less than about 0.9% w/w; less than about 0.8% w/w; less than about 0.7% w/w; less than about 0.6% w/w; less than about 0.5% w/w; less than about 0.4% w/w; less than about 0.3% w/w; less than about 0.2% w/w; less than about 0.1% w/w; or less than about 0.05% w/w. The presence of a film or coating may reduce and/or prevent premature disintegration of the herbicide composition and/or reduce the time that a solid form of the herbicide composition is exposed to an atmosphere comprising water, prior to administering the herbicide composition to a body of water.

### Aqueous Formulations

Aqueous formulations comprising a herbicide composition as defined herein are also contemplated.

Whilst the herbicide composition may be used in a solid form, for example a tablet, in certain situations there may be a need to dissolve the herbicide composition in a suitable amount of water for improved dispersal over a region of a body of water. In one embodiment a herbicide composition as defined herein is used to form an aqueous formulation by dissolving it in a volume of water acting as a carrier. The concentration of one or more herbicides (and optionally other active agents) can be tailored depending on the types of plants being controlled in the body of water and/or the size of the area of the body of water being treated.

### Methods of Formulating the Herbicide Composition

Disclosed herein is a method of manufacturing a herbicide composition as defined herein.

In one embodiment the method of manufacturing the herbicide composition comprises a step of compressing a mixture comprising:
at least one herbicide (for example a protoporphyrinogen oxidase inhibitor, such as flumioxazin);
an effervescent agent; and
optionally one or more excipients.

The method of manufacturing the herbicide composition may also comprise one or more of the following steps:
milling a compressed form of the mixture;
applying a water soluble coating to the mixture; and/or
applying a water soluble film to the mixture.

The mixture being compressed may be in the form of a powder.

In addition, the mixture may be milled to a predetermined particle size, for example to optimise the dispersion and/or uptake of one or more active ingredients present in the herbicide composition in water.

In one embodiment, the method of manufacturing the herbicide composition further comprises the step of applying a coating or a film to the herbicide composition.

In a preferred embodiment, the coating or film is water-soluble.

### Methods of Use

Disclosed herein is a method for controlling one or more aquatic plants (for example submerged, emergent and/or floating plants), in or on a body of water, the method comprising a step of introducing a herbicide composition that is capable of dispersing at least one active agent as described herein to contact at least a portion of the aquatic plants present in the body of water, following the introduction of the herbicide composition to the body of water.

Also disclosed herein is a method for controlling one or more aquatic plants in or on a body of water, wherein the method utilises a herbicide composition which has been formulated such that following introduction to the body of water, the herbicide composition disintegrates or dissolves in the body of water, and the one or more active agents, for example one or more herbicides, are dispersed to contact at least a portion of at least one of submerged, emergent and floating plants present in the body of water.

Also disclosed herein is the use of a herbicide composition as defined herein, which is capable of dispersing an active ingredient to contact at least a portion of at least one of submerged, emergent and/or floating plants in or on a body of water, following introduction of the herbicide composition to the body of water.

In one embodiment a discrete solid form of the herbicide composition is introduced to at least one section of the body of water for the methods and uses described herein.

The herbicide composition disclosed herein may be used as part of an aquatic plant control system, for example to control submerged, emergent and/or floating plants in or on a body of water. This plant control system may comprise a step of dispersing a herbicide composition as defined herein to at least a portion of a body of water. The system may further comprise additional steps whereby other actions, such as dispersing alternative herbicides on flora which is not contained within the body of water, e.g., bushes or plants on banks surrounding the body of water, are also undertaken.

The herbicide compositions and methods described herein may be used in conjunction with any other control methods and techniques known in the art to control flora and/or fauna in or around a body of water. Other techniques include, but are not limited to:
sub-surface injection;
application to the foliage;
weighting of herbicides in mixtures with guar gum;
biological control of weeds; and/or
mechanical harvesting of weeds.

In one embodiment a herbicide composition as defined herein is introduced into a body of water to control aquatic plants, for example at least one of submerged, emergent or floating plants in the body of water. In another embodiment, a herbicide composition as defined herein is introduced into the body of water to control at least two of submerged, emergent or floating plants in the body of water. In yet another embodiment, a herbicide composition as defined herein is introduced into the body of water to control submerged, emergent or floating plants in the body of water.

In one embodiment, an individual or party introducing a herbicide composition as defined herein to the body of water does not come in to contact with the body of water. The individual may be at least about 1 m away from the body of water. For example the individual may be: at least about 2 m; at least about 3 m; at least about 4 m; at least about 5 m; at least about 6 m; at least about 7 m; at least about 8 m; at least about 9 m; at least about 10 m; at least about 11 m; at least about 12 m; at least about 13 m; at least about 14 m; at least about 15 m; at least about 16 m; at least about 17 m; at least about 18 m; at least about 19 m; or at least about 20 m from the body of water.

In another embodiment, an individual or party introducing the herbicide composition to the body of water throws, drops or places the herbicide composition into the body of water. In yet another embodiment, the individual or party do not use any specialised equipment, e.g., mechanical means such as a slingshot or a drone, for distributing the herbicide composition. For example the individual only uses the movement of a human arm or body movement to introduce the herbicide composition to the body of water.

Use of the herbicide compositions as described herein may have health and safety benefits. In one embodiment an individual can distribute herbicide compositions as defined herein from, for example, the sides or banks of a body of water, removing the need to enter or directly contact the body of water, e.g., by wading or from a boat. Contacting a body of water may present health and safety implications due to the presence of dangerous flora such as blue-green algae. Alternatively the body of water may comprise fauna, for example crocodilian species, or a large concentration of insects such as mosquitos, making it difficult, dangerous or hazardous for a person to directly enter or contact the body of water. Obstacles present in the water, such submerged logs, may also present a drowning hazard to individuals.

Factors that will dictate the characteristics of the herbicide composition, for example: the concentration of one or more active agents present in the herbicide composition; the form and/or shape of the herbicide composition; the weight and/or density of the herbicide composition; and/or the size of the herbicide composition, include but are not limited to:
the volume of water in the body of water being treated;
the size and depth of the body of water being treated
the type and number of active agents present in the herbicide composition;
and/or
the type and/or number of plants present in the body of water.

The herbicide composition may be of sufficient size and comprise a sufficient concentration of one or more active ingredients to control aquatic plants in an entire body of water, or a portion thereof. Alternatively, one or more discrete units of the herbicide composition may be introduced to a portion of the body of water, or across the entire body of water.

In one embodiment, a discrete solid form of a herbicide composition as defined herein is introduced to a section of a body of water to control one or more of: submerged, emergent and floating plants, in the body of water.

In another embodiment, the method comprises using a herbicide composition which is formulated such that following introduction to the body of water, the herbicide composition disintegrates or dissolves, and one or more active agents present in the herbicide composition are dispersed to contact at least one of: submerged, emergent and floating plants, in the body of water. In one embodiment the herbicide composition is capable to dispersing the at least one active agent to all three of submerged, emergent and floating plants in the body of water.

In a preferred embodiment, the herbicide composition used in the method for controlling one or more aquatic plants in or on a body of water, is a herbicide composition as defined herein.

In one embodiment the herbicide composition is formulated and/or used in a method of controlling one or more of submerged, emergent and/or floating plants, in or on a body of water, such that only the one or more of submerged, emergent and/or floating plants is controlled and the herbicide does not affect any other flora and/or fauna, e.g. native flora or fauna which should be preserved or protected. In yet another embodiment the herbicide composition is formulated to target a specific plant or group of plants.

A herbicide composition as defined herein may be used directly, for example in a discrete forms such as a tablet, to control one or more plants, for example submerged, emergent and/or floating plants, in or on a body of water. Alternatively, a herbicide composition as defined herein may be used to prepare a spray solution, wherein the spray solution is dispersed to one or more aquatic plants in or on a body of water (for example submerged, emergent and/or floating plants).

Alternatively, or in addition to a method as defined herein, a spray solution comprising a herbicide composition as defined herein may be dispersed on one or more aquatic plants in the body of water optionally prior to, in conjunction with, or after introducing a herbicide composition (possibly in a solid form, for example a tablet) as defined herein, to the body of water. In one embodiment, the method defined herein comprises a step of dissolving a herbicide composition as defined herein, in water and dispersing the resulting product over the one or more aquatic plants.

The herbicide composition defined herein may be used as part of a plant control system in an environment comprising a body of water. This plant control system may comprise a step of dispersing a herbicide composition as defined herein to the body of water. The system may further comprise additional steps whereby other actions, such as dispersing alternative herbicides on flora which is not contained within the body of water, e.g., bushes or plants on banks surrounding the body of water. The plant control system may also comprise steps for controlling local fauna such as mosquitos, by dispersing one or more insecticides.

Appropriate aquatic plants that may be treated are known in the art. Examples of aquatic plants includes, but is not limited to: Alternanthera philoxeroides, Azolla spp., Cabomba caroliniana, Cabomba spp., Ceratophyllum demersum, Chara spp., Cladophora spp., Egeria densa, Eichhornia. Spp., Equisetum spp, Elodea canadensis, Gymnocoronis spilanthoides, Heteranthera remformis, Hereranthera zosterifolia, Hydrilla verticillicata, Hydrocotyle spp., Hydrocleys nymphoides, Hygrophila polysperma, Hygrophila costata, Hymenachne amplexicaulis, Ipomoea aquatica, Lagarosiphon spp. Lemna spp., Limnobium spp., Limnocharis flava, Ludwigia spp., Mayaca fluviatilis, Myriophyllum spicatum, Myriophyllum heterophyllum, Myriophyllum spp., Najas guadalupensis, Nitella spp., Nymphaea spp., Persicaria decipiens, Pistia stratoites, Pitophora spp., Potamogeton crispus, Potamogeton pectinatus, Potamogeton diversifolius, Potamogeton spp., Sagittaria spp., Salivinia spp., Trapa spp., Vallisneria spp., Wolffia spp, and mixtures thereof.

The herbicide composition described herein may be introduced into a body of water by any means, such as agricultural application apparatus, known in the art. For example the herbicide composition may be formulated so that an individual can throw or place the herbicide composition directly on plants in the body of water or in the body of water. Alternatively the individual could use alternative means such as mechanical means, e.g., a sling shot or a remotely controlled drone.

The herbicide composition may be used for high-volume spraying in a diluted form. In this application the herbicide composition can be dissolved inside the spray tank to release the active ingredient. The resulting solution could be applied to a portion of aquatic plants present in or on a body of water, for example the foliage, and/or be injected below the surface of the body of water to control, inter alia, submerged plants. Situations where this application may be required include, but are not limited to:
When the volume of water in the body of water is less than the minimum volume of water required to achieve the maximum concentration with a single discrete solid form of the herbicide composition (for example a tablet). One or more tablets may be dissolved in the minimum amount of water required to achieve the maximum concentration, with the resulting solution being applied by appropriate means, such as a spray, to a target area.
When the body of water to be treated is shallow with a large surface area. In this instance, placement of a limited number of tablets may not achieve the required degree of physical distribution of the active ingredient to give control of target plants in all parts of the body of water, or portions thereof.
When the body of water is shallow and movement of the water is limited by physical obstacles, e.g., logs and rocks or dense growth of the weeds. In this instance, application of the same amount of active ingredient as would have been contained in a discrete solid form, but is injected in diluted form may give an improved distribution of the active ingredient to all parts of the body of water resulting in improved control of weeds.
When the plants that need to be controlled are exclusively floating type and more susceptible to foliar-applied herbicides, or in re-growth and re-establishment situations where the amount of the plants floating on the body of water does not require a submerged application.

### Example Embodiments

The present disclosure may be described, but no necessarily limited to, the following example embodiments.

1. A herbicide composition which controls submerged, emergent and/or floating plants in or on a body of water, the herbicide composition comprising:
one or more protoporphyrinogen oxidase inhibitors;
an effervescent agent to disperse the one or more protoporphyrinogen oxidase inhibitors upon contact of the herbicide composition with the body of water; and
optionally one or more excipients,
   wherein the herbicide composition is formulated to disperse the one or more protoporphyrinogen oxidase inhibitors:
in a first stage below the surface of the body of water; and
in a second stage at or substantially at the surface of the body of water.
   2. The herbicide composition of example embodiment 1, wherein the one or more protoporphyrinogen oxidase inhibitors are selected from the group consisting of: acifluorfen, azafenidin, bifenox, butafenacil, carfentrazone-ethyl, flufenpyr-ethyl, flumiclorac, flumiclorac-pentyl, flumioxazin, fluoroglycofen, fluthiacet-methyl, fomesafen, lactofen, oxadiargyl, oxadiazon, oxyfluorfen, pyraflufen-ethyl, saflufenacil, sulfentrazone and trifludimoxazin, salts and esters thereof, and mixtures thereof.
   3. The herbicide composition according to example embodiment 1 or example embodiment 2, wherein the herbicide composition is formulated to disperse the one or more protoporphyrinogen oxidase inhibitors in a substantially vertical column in the first stage, such that the one or more protoporphyrinogen oxidase inhibitors are capable of contacting at least a portion of the submerged, emergent and/or floating plants.
   4. The herbicide composition according to any one of example embodiments 1 to 3, wherein the density of the herbicide composition is in a range of about 1 g cm⁻³ to about 2 g cm⁻³.
   5. The herbicide composition according to any one of example embodiments 1 to 4, wherein the density of the herbicide composition is in a range of about 1.2 g cm⁻³ to about 1.6 g cm⁻³.
   6. The herbicide composition according to any one of example embodiments 1 to 5, wherein the one or more protoporphyrinogen oxidase inhibitors are present in the herbicide composition in a range of about 1% w/w to about 60% w/w.
   7. The herbicide composition according to any one of example embodiments 1 to 6, wherein the effervescent agent is present in the herbicide composition in an amount of about 40 wt % and about 90 wt %.
   8. The herbicide composition according to any one of example embodiments 1 to 7, wherein the effervescent agent comprises a combination of an acid component and a base component.
   9. The herbicide composition according to example embodiment 8, wherein the acid component comprises a compound selected from: adipic acid, ascorbic acid, benzoic acid, citric acid, fumaric acid, glutaric acid, lactic acid, lauric acid, malic acid, maleic acid, malonic acid, oxalic acid, phthalic acid, sorbic acid, succinic acid, tartaric acid, acid anhydrides of such acids, acid salts of such acids, ammonium phosphate, potassium bitartrate, potassium phosphate, dipotassium phosphate, disodium pyrophosphate, sodium acid pyrophosphate, sodium phosphate, disodium phosphate, and mixtures thereof.
   10. The herbicide composition according to example embodiment 8 or example embodiment 9, wherein the base component comprises a compound selected from: a bicarbonate, a carbonate, or mixtures thereof.
   11. The herbicide composition according to any one of example embodiments 8 to 10, wherein the base component comprises a compound selected from: alkali metal bicarbonates, alkaline earth metal bicarbonates, organic bicarbonates, alkali metal carbonates, alkaline earth metal carbonates, organic carbonates, alkali metal sesquicarbonates, alkaline earth metal sesquicarbonates, organic sesquicarbonates, and mixtures thereof.
   12. The herbicide composition according to any one of example embodiments 8 to 11, wherein the base component comprises: ammonium bicarbonate, calcium bicarbonate, lithium bicarbonate, magnesium bicarbonate, potassium bicarbonate, sodium bicarbonate, arginine carbonate, ammonium carbonate, calcium carbonate, lysine carbonate, potassium magnesium carbonate, sodium carbonate, sodium glycine carbonate, sodium sesquicarbonate, zinc carbonate, or mixtures thereof.
   13. The herbicide composition according to any one of example embodiments 1 to 12, wherein the herbicide composition has a mass in the range of about 25 g to about 1000 g.
   14. The herbicide composition according to any one of example embodiments 1 to 13, wherein the herbicide composition has a mass in the range of about 60 g to about 300 g.
   15. The herbicide composition according to any one of example embodiments 1 to 14 is formulated to disperse the one or more protoporphyrinogen oxidase inhibitors:
in the first stage for at least ten minutes below the surface of the body of water to control submerged weeds and algae, as well as the submerged portion of emergent weeds; and
then in the second stage at or substantially at the surface of the body of water to simultaneously control floating weed.
   16. A herbicide composition comprising a herbicide (for example flumioxazin), an effervescent agent and optionally one or more excipients.
   17. The herbicide composition according to any one of example embodiments 1 to 15, wherein the one or more protoporphyrinogen oxidase inhibitors is flumioxazin.
   18. The herbicide composition according to example embodiment 16 or example embodiment 17, wherein the herbicide composition is formulated such that the final dilution level of flumioxazin in the body of water is in a range of about 5 parts-per-billion to about 600 parts-per-billion
   19. The herbicide composition according to any one of example embodiments 16 to 18, wherein the herbicide composition is formulated such that the final dilution level of flumioxazin in the body of water is in a range of about 200 parts-per-billion to about 400 parts-per-billion.
   20. The herbicide composition according to any one of example embodiments 16 to 19, wherein the herbicide composition is formulated such that the final dilution level of flumioxazin in the body of water is at least about 400 parts-per-billion.
   21. The herbicide composition according to any one of example embodiments 1 to 20, wherein the herbicide composition is in the form of tablet and has a diameter in a range of about 20 mm to about 100 mm.
   22. The herbicide composition according to any one of example embodiments 1 to 21, wherein the herbicide composition is in a solid form and has a height to diameter ratio in a range of about 1:1 to about 1:5.
   23. The herbicide composition according to any one of example embodiments 1 to 22, further comprising at least one other herbicide.
   24. The herbicide composition according to any one of example embodiments 1 to 23, further comprising at least one other herbicide selected from the group consisting of: is calcium dodecyl benzene sulphonate, 2,4-D, acrolein, amine salts of endothall, bifenox, bipyribac sodium, butachlor, carfentrazone-ethyl, chlorfenac, chlorthiamide, copper and chelated copper, copper sulphate, cyanatryn, dicopper dihydroxide carbonate, dichlobenil, dipotassium salts of endothall, diquat, diuron, endothall, fluridone, fluchloralin, glyphosate, hexazinone, hydrogen dioxide, hydrogen peroxide, imazamox, imazapyr, mancozeb, nitrofen, nabam, oxadiazon, metsulfuron, paraquat, penoxulam, pentachorophenol, pendimethalin, pH4062, R24191, simazine, sodium carbonate peroxhydrate, terbutryn, thiram, topramezone, and mixtures thereof.
   25. The herbicide composition according to any one of example embodiments 1 to 24, wherein the herbicide composition comprises one or more excipients selected from: a dye, a marker, a pigment, a lubricant, a glidant, an anti-adherent solid carriers or fillers, surfactants, dispersants, emulsifiers, adjuvants, solubilizers, penetration enhancers, protective colloids, adhesion agents, thickeners, compatibilizers, anti-freezing agents, binders, and mixtures thereof.
   26. The herbicide composition according to any one of example embodiments 1 to 25, wherein the herbicide composition comprises a dye selected from the group consisting of: inorganic pigments, iron oxide, titanium oxide, Prussian blue, organic dyes, alizarin dye, azo dyes, metal phthalocyanines, Oleum Blue Powder (C.I Acid Blue 9), and mixtures thereof.
   27. The herbicide composition according to any one of example embodiments 1 to 26, wherein the herbicide composition is encapsulated in a water-soluble film or a water-soluble coating.
   28. The herbicide composition according to any one of example embodiments 1 to 27, wherein the herbicide composition is encapsulated in a water-soluble film.
   29. The herbicide composition according to example embodiment 27 or example embodiment 28, wherein the water-soluble film is selected from the group consisting of: Type Z films, Type C films, Type W films, and mixtures thereof.
   30. The herbicide composition according to any one of example embodiments 1 to 29, wherein the herbicide composition further comprises a water soluble film, wherein the water-soluble film comprises: poly(vinyl alcohol), poly(vinyl acetate), poly(ethylene oxide), poly(N-vinyl pyrrolidone), poly(acrylic acid), poly(methacrylic acid), poly(acrylamide) or copolymers or blends or mixtures thereof, cellulose, glycerol, poly(ethylene glycol), citric acid, urea, water, sodium acetate, potassium nitrate, ammonium nitrate, fertilizers, agar, xanthan gum, alginate, hydroxypropylcellulose, methylcellulose, carboxymethylcellulose, poly(acrylic acid), sodium polyacrylate, guar gum, pectin, a water-soluble protein, a water-soluble carbohydrate, gelatin, sodium carboxymethylcellulose and blends or crosslinked versions thereof, or mixtures thereof.
   31. The herbicide composition according to any one of example embodiment 1 to 30, wherein the herbicide composition is encapsulated in a water-soluble coating.
   32. The herbicide composition according to any one of example embodiments 1 to 31, wherein the herbicide composition is encapsulated in a water-soluble coating, wherein the water-soluble coating comprises: polyethylene glycol, polyvinyl alcohol, polyvinylpyrrolidone, hydroxymethylcellulose, hydroxypropylcellulose, methylcellulose, or a mixture thereof.
   33. The herbicide composition according to any one of example embodiments 27 to 32, wherein the water-soluble film or water-soluble coating is formulated to dissolve within about 5 minutes of the herbicide composition contacting the body of water.
   34. The herbicide composition according to any one of example embodiments 1 to 33, wherein the herbicide composition further comprises at least one of: an insecticide, an algaecide, a bactericide, fungicide, or a combination thereof.
   35. The herbicide composition according to any one of example embodiments 1 to 34, wherein the herbicide composition further comprises at least one insecticide, wherein the at least one insecticide is selected from the group consisting of: carbamates, organophosphates, cyclodiene organochlorines, phenylpyrazoles (fiproles), pyrethroids, pyrethrins, neonicotinoids, nicotine, sulfoximine, spinosyns, avermectins, milbemycins, juvenile hormone analogues, fenoxycarb, pyriproxyfen, alkyl halides, chloropicrin, fluorides, pyridine azomethine derivatives, clofentezine, hexythiazox, etoxazole, Bacillus thuringiensis and the insecticidal proteins they produce, B. sphaericus and the insecticidal proteins they produce, diafenthiuron, organotin miticides, propargite, tetradifon, chlorfenapyr, nereistoxin analogues, benzoylureas, buprofezin, cyromazine, diacylhydrazines, amitraz, hydramethylnon, bifenazate, METI acaricides and insecticides, rotenone, oxadiazines, semicarbazones, tetronic and tetramic acid derivatives, phosphides, cyanides, beta-ketonitrile derivatives, carboxanilides, diamides, flonicamid, azadirachtin, dicofol, lime sulphur, sulphur, and mixtures thereof.
   36. The herbicide composition according to any one of example embodiments 1 to 35, wherein the herbicide composition further comprises at least one insecticide, wherein the at least one insecticide is selected from the group consisting of: abamectin, acephate, acetamiprid, allethrin, alpha-cypermethrin, aluminium phosphide, amitraz, azadirachtin, azamethiphos, azinphos methyl, Bacillus thuringiensis aizawai, Bacillus thuringiensis israelensis, Bacillus thuringiensis kurstaki, Bacillus sphaericus, Bacillus thuringiensis tenebrionis, bendiocarb, beta-cyfluthrin, bifenazate, bifenthrin, bioallethrin, bioresmethrin, bistrifluron, buprofezin, cadusafos, carbaryl, carbofuran, carbosulfan, chlorantraniliprole, chlorfenvinphos, chlorfluazuron, chlorfenapyr, chloropicrin, chlorpyrifos, chlorpyrifos-methyl, clofentezine, clothianidin, cyantraniliprole, cyfluthrin, cypermethrin, cyromazine, deltamethrin, diafenthiuron, diazinon, dichlorvos, dicofol, diflubenzuron, dimethoate, dinotefuran, emamectin benzoate, esbiothrin, ethion, etoxazole, esfenvalerate, fenamiphos, fenbutatin oxide, fenitrothion, fenoxycarb, fenpyroximate, fenthion, fenvalerate, fipronil, flonicamid, flubendiamide, flufenoxuron, flumethrin, gamma-cyhalothrin, hexaflumuron, hexythiazox, hydramethylnon, imidacloprid, imiprothrin, indoxacarb, lambda-cyhalothrin, lufenuron, magnesium phosphide, maldison (malathion), metaflumizone, methidathion, methiocarb, methomyl, methoprene, methoxyfenozide, methyl bromide, mevinphos, milbemectin, oxamyl, omethoate, permethrin, phorate, phosmet, phosphine, pirimicarb, pirimiphos-methyl, prallethrin, profenofos, propargite, propoxur, prothiofos, pymetrozine, pyrethrins, pyridaben, pyriproxyfen, spinosad, spinetoram, spirotetramat, sulfoxaflor, tau-fluvalinate, tebufenozide, tebufenpyrad, temephos, terbufos, tetradifon, tetramethrin, thiacloprid, thiamethoxam, thiodicarb, transfluthrin, trichlorfon, triflumuron, zeta-cypermethrin, and mixtures thereof.
   37. The herbicide composition according to any one of example embodiments 1 to 36, wherein the herbicide composition further comprises at least one algaecide, wherein the at least one algaecide is selected from: benzalkonium chloride, bethoxazim, copper sulphate, cybutryne, dichlone, dichlorophen, diuron, endothall, fentin, hydrated lime, isoproturon, methabenzthiazuron, nabam, oxyfluorfen, pentachlorophenol laurate, quinoclamine, quinonamid, simazine, terbutryn and tiodonium, and mixtures thereof.
   38. The herbicide composition according to any one of example embodiments 1 to 37, wherein the herbicide composition further comprises at least one bactericide, wherein the at least one bactericide is selected from the group consisting of: disinfectants including active chlorine compounds, active oxygen compounds, iodine, concentrated alcohols, phenolic substances, cationic surfactants, strong oxidizers, heavy metals and their salts, strong acids, alkalis above pH 13; antiseptics including chlorine preparations, iodine preparations, peroxides, alcohols, sorbic acid, benzoic acid, lactic acid, salicylic acid, phenolic compounds, and mixtures thereof.
   39. The herbicide composition according to any one of example embodiments 1 to 38, wherein the water content is less than about 0.1% w/w.
   40. The herbicide composition according to any one of example embodiments 1 to 39, wherein the herbicide composition is formulated such that it controls at least two of submerged, emergent and floating plants in or on the body of water.
   41. The herbicide composition according to any one of example embodiments 1 to 40, wherein the herbicide composition is formulated such that it controls submerged, emergent and floating plants in or on the body of water.
   42. An aqueous formulation comprising a herbicide composition according to any one of example embodiments 1 to 41.
   43. A method of manufacturing a herbicide composition according to any one of example embodiments 1 to 41, the method comprising the step of compressing a mixture comprising:
one or more protoporphyrinogen oxidase inhibitors;
an effervescent agent; and
optionally one or more excipients.
   44. The method according to example embodiment 43, wherein the method further comprises the step of applying a coating or a film to the herbicide composition.
   45. The method according to example embodiment 43 or example embodiment 44, wherein in the one or more protoporphyrinogen oxidase inhibitors is flumioxazin.
   46. A method for controlling submerged, emergent and/or floating plants in or on a body of water, the method comprising a step of introducing a herbicide composition according to any one of example embodiments 1 to 41 to the body of water.
   47. The method according to example embodiment 46, wherein the herbicide composition is formulated such that following introduction to the body of water, the herbicide composition disintegrates and one or more protoporphyrinogen oxidase inhibitors is dispersed to contact the submerged, emergent and/or floating plants.
   48. The method according to example embodiment 46 or example embodiment 47, wherein in the one or more protoporphyrinogen oxidase inhibitors is flumioxazin.
   49. The method according to any one of example embodiments 46 to 48, wherein the herbicide composition is in the form of a tablet.
   50. The method according to any one of example embodiments 46 to 49, wherein an aqueous formulation comprising a herbicide formulation is dispersed on one or more aquatic plants in or on the body of water prior to, in conjunction with, or after introducing the herbicide composition.
   51. The method according to example embodiment 50, wherein the herbicide formulation is a herbicide composition according to any one of example embodiments 1 to 41.
   52. A method for controlling submerged, emergent and/or floating plants in or on a body of water, the method comprising a step of dissolving the herbicide composition according to any one of example embodiments 1 to 41 in a composition comprising water and dispersing the resulting product over the submerged, emergent and/or floating plants.
   53. The method according to any one of example embodiments 46 to 52, wherein the herbicide composition is formulated such that it controls at least one of submerged, emergent and floating plants in or on the body of water.
   54. The method according to any one of example embodiments 46 to 53, wherein the herbicide composition is formulated such that it controls at least two of submerged, emergent and floating plants in or on the body of water.
   55. The method according to any one of example embodiments 46 to 54, wherein the herbicide composition is formulated such that it controls submerged, emergent and floating plants in or on the body of water.
   56. The method according to any one of example embodiments 46 to 55, wherein at least one of the submerged, emergent and/or floating plants are selected from the group consisting of: Alternanthera philoxeroides, Azolla spp., i Cabomba caroliniana, Ceratophyllum demersum, Cladophora spp., Egeria densa, Hereranthera zosterifolia, Hydrilla verticillicata, Hydrocotyle spp., Hygrophila polysperma, Ipomoea aquatica, Lemna spp., Limnobium spp., Macaya fluviatilis, Najas guadalupensis, Nymphaea spp., Persicaria decipiens, Pistia stratoites, Pitophora spp., Potamogeton crispus, Potamogeton pectinatus, Potamogeton diversifolius, Potamogeton spp., Sagittaria spp., Salivinia spp., Wolffia spp., Myriophyllum, spicatum and Mysiophyllum heterophyllum, and mixtures thereof.
   57. Use of a herbicide composition according to any one of example embodiments 1 to 41 to control submerged, emergent and/or floating plants in or on a body of water.
   58. The use according to example embodiment 57, wherein the one or more protoporphyrinogen oxidase inhibitors is flumioxazin.
   59. The use according to example embodiment 57 or example embodiment 58, wherein a discrete solid form of the herbicide composition is introduced to the body of water.
   60. The use according to example embodiment 59, wherein the discrete solid form is a tablet.
   61. The use according to any one of example embodiments 57 to 60, wherein the herbicide composition is formulated such that following introduction to the body of water, the herbicide composition disintegrates and the active agent is dispersed to contact the submerged, emergent and/or floating plants.
   62. Use of a herbicide composition according to any one of example embodiments 1 to 41 in the synthesis of an aqueous formulation for dispersing on submerged, emergent and/or floating plants in or on a body of water.
   63. The use according to any one of example embodiments 57 to 62, wherein the herbicide composition is formulated such that it controls at least one of submerged, emergent and floating plants in or on the body of water.
   64. The use according to any one of example embodiments 57 to 63, wherein the herbicide composition is formulated such that it controls at least two of submerged, emergent and floating plants in or on the body of water.
   65. The use according to any one of example embodiments 57 to 64, wherein the herbicide composition is formulated such that it controls submerged, emergent and floating plants in or on the body of water.
   66. Use of the aqueous formulation according to example embodiment 42 for controlling one or more plants.
   67. The use according to example embodiment 66 wherein the one or more plants are submerged, emergent and/or floating plants in or on a body of water.
   68. The use according to example embodiment 66 or example embodiment 67, wherein the one or more protoporphyrinogen oxidase inhibitors is flumioxazin.
   69. A method for controlling one or more aquatic plants in or on a body of water, the method comprising a step of introducing a herbicide composition that is capable of dispersing an active ingredient to contact submerged, emergent and/or floating plants following the introduction of the herbicide to the body of water.
   70. The method according to example embodiment 69, wherein a discrete solid form of the herbicide composition is introduced to a section of the body of water.
   71. The method according to example embodiment 69 or example embodiment 70, wherein the herbicide composition is formulated such that following introduction to the body of water, the herbicide composition disintegrates and the active agent is dispersed to contact the submerged, emergent and floating plants.
   72. The method according to any one of example embodiments 69 to 71, wherein the herbicide composition is a herbicide composition according to any one of example embodiments 1 to 41.
   73. Use of a herbicide composition that is capable of dispersing an active ingredient to contact submerged, emergent and/or floating plants in or on a body of water, following introduction of the herbicide composition to the body of water.
   74. The use according to example embodiment 73, wherein a discrete solid form of the herbicide composition is introduced to a section of the body of water.
   75. The use according to example embodiment 73 or example embodiment 74, wherein the herbicide composition is formulated such that following introduction to the body of water, the herbicide composition disintegrates and the active agent is dispersed to contact the submerged, emergent and floating plants.
   76. The use according to any one of example embodiments 73 to 75, wherein the herbicide composition is a herbicide composition according to any one of example embodiments 1 to 41.
   77. The use according to any one of example embodiments 57 to 68 or 73 to 76, wherein an individual introducing the herbicide composition to the body of water does not come in to contact with the body of water.
   78. The method according to any one of example embodiments 46 to 56 or 69 to 72, wherein an individual introducing the herbicide composition to the body of water does not come in to contact with the body of water and/or is at least about 1 m away from the body of water.
   79. The method according to any one of example embodiments 46 to 56, 69 to 72 or 78, wherein an individual introducing the herbicide composition to the body of water throws, drops or places the herbicide composition into the body of water, with the proviso that the individual only uses the movement of a human arm or body movement to introduce the herbicide composition to the body of water.

### EXAMPLES

### Example 1—Exemplary Herbicide Compositions

### General Method for Forming Herbicide Compositions

In general, the dry ingredients are milled or blended mechanically and then either fed into a tablet press, for example a high pressure industrial tablet press, or a compactor, or the milled or blended powder is moistened, extruded and dried. Exemplary formulations are shown in Table 2.

TABLE 2
Examples of herbicide formulations as disclosed herein

| | Herbicide Composition | | |
|---|---|---|---|
| | 1 | 2 | 3 |
| Component | % w/w | % w/w | % w/w |
| Flumioxazin | 10.1 | 10.1 | 10.1 |
| Citric Acid (balance) | 41.65 | 44.4 | 47.9 |
| Magnesium Stearate | 1.5 | 0.5 | 1.0 |
| Polycarboxylate dispersant | 5 | 5 | 5 |
| (Tersperse ® 2700, Huntsman) | | | |
| Anionic wetting agent | 2 | 2 | 2 |
| (Terwet ®1004, Huntsman) | | | |
| Sodium Bicarbonate | 30.55 | 30 | 25 |
| Polyvinylpyrrolidone | 2.0 | 2 | 2 |
| (Molecular weight: >1,000,000 g mol⁻¹) | | | |
| Polyethylene glycol | 7.0 | 4 | 6 |
| (Molecular weight: 3500 to 4500 g mol⁻¹) | | | |
| Oleum Blue Powder | 0.2 | 2.0 | 1.0 |
| Total | 100 | 100 | 100 |

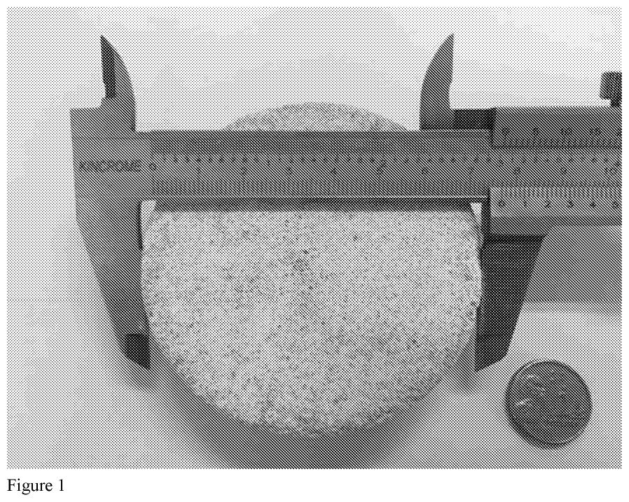

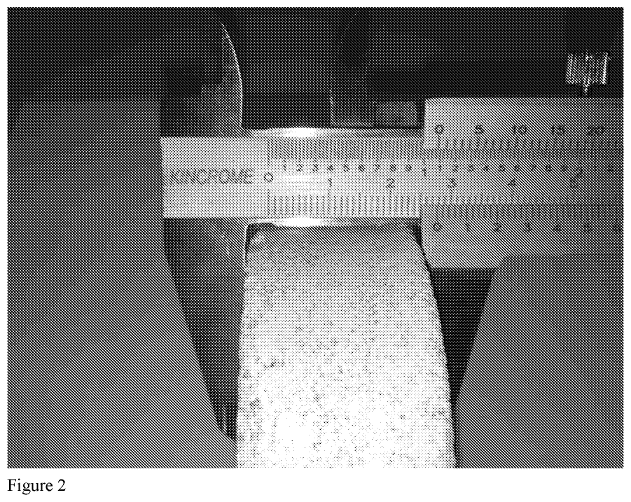

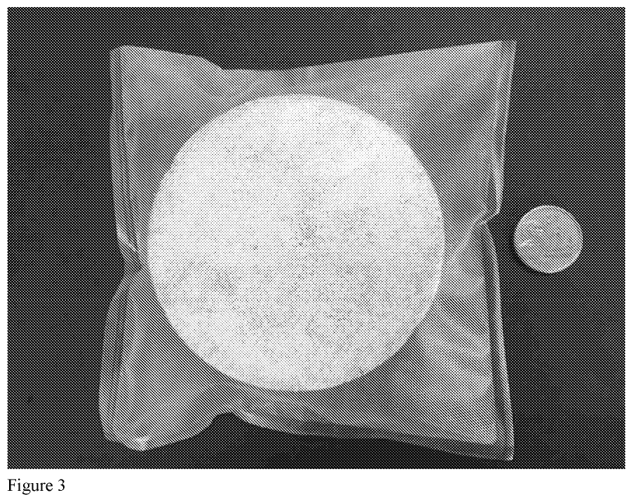

The herbicide composition may be compressed to form a tablet, for example as shown in FIG. 1, FIG. 2 or FIG. 3. The depicted tablet is these figures has a diameter of approximately 77 mm and a thickness of approximately 28 mm. The tablets here are Composition 1 in Table 2.

In FIG. 3 the herbicide composition is placed in a packet composed of a poly(vinyl acetate) Type C material (Solpak).

### Example 2—Evaluation of the Physical Behaviour of SCAL 5174, a Large-Diameter Effervescent Tablet Containing 10% Flumioxazin, in Water

A tablet comprising the formulation of Composition 1 of Table 2 was manufactured using a high-pressure industrial tablet press. The tablet dimensions were:
Diameter: 65 mm
Height (thickness): 30 mm
Weight: 134 g

The tablet was wrapped in a Type C water soluble film and was clear.

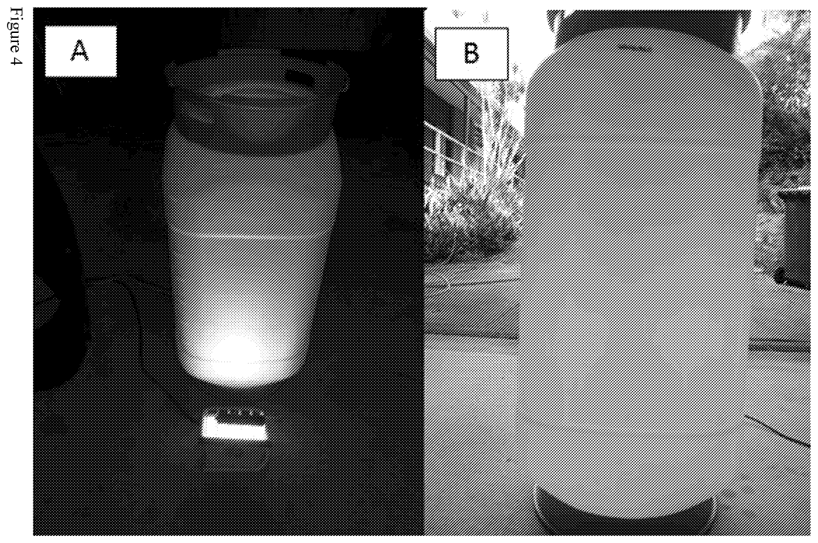

The physical behaviour of the tablet was observed in a 100 L container, with a column depth of 1 m. A strong backlight was installed behind the container, which illuminated the water column so that vertical movement of the rising tablet could be easily observed when viewed from the front (FIG. 4).

The temperature of the water in the container was 28° C. and the pH was 6.9.

The following parameters were recorded:
Total time from insertion to full dissolution
Weight of the tablet at predetermined intervals
Relative position of the dissolving tablet in the water column
Other observations concerning physical behaviour of the tablet

### Results

The results are shown in Table 3.

TABLE 3
Dissolution study of herbicide composition comprising flumioxazin.

| | | | | | | |
|---|---|---|---|---|---|---|
| Time (min) | 0 | 10 | 20 | 21 | 22 | 27 |
| Tablet weight (g) | 134 | 65 | 22 | * | * | 7 |
| Position in water column | Bottom | Bottom | Bottom | Starts to rise | At the surface | At the surface |

| | | | | | |
|---|---|---|---|---|---|
| Time (min) | 30 | | 33 | | 35 |
| Tablet weight | 1 | g | <1 | g | Completely dissolved |

| | | | |
|---|---|---|---|
| Position in column | At the surface | At the surface | At the surface |

*Not measured

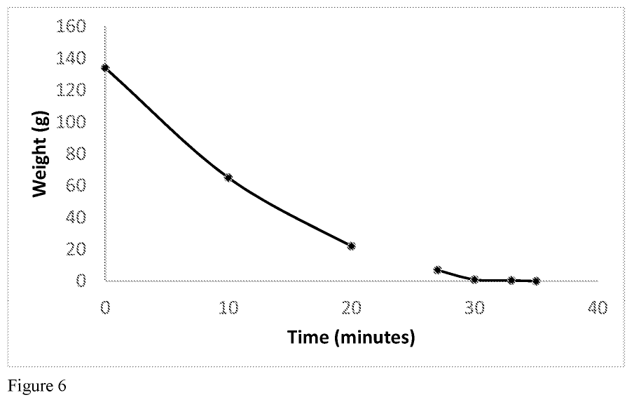

A graph of the results is shown in FIG. 6.

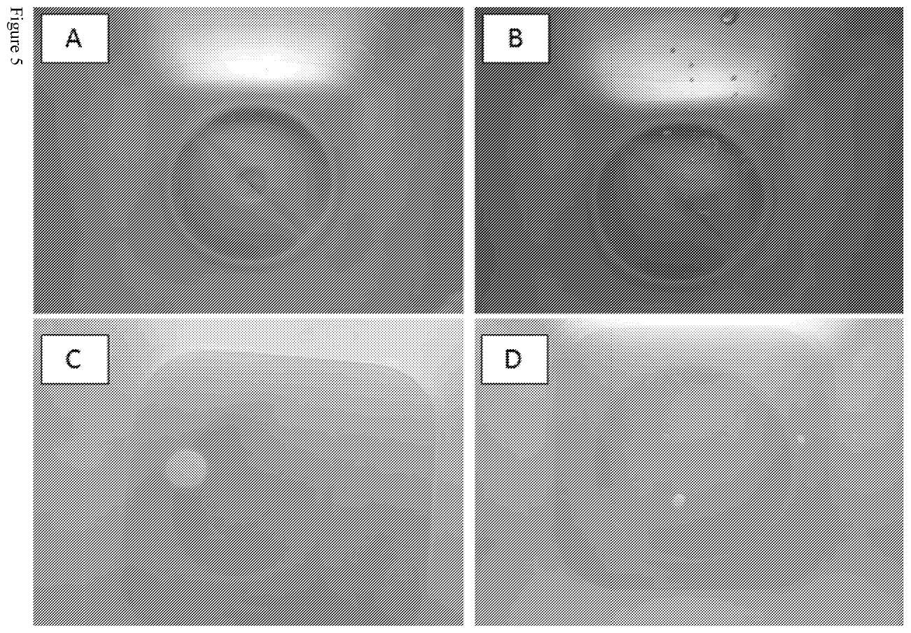

The following observations were made on the behaviour of the tablet:
When dropped into the tank, the tablet began effervescing immediately (FIG. 5, image B).
The water-soluble wrapping was completely dissolved within two minutes.
The tablet continued to effervesce and diminished in size, but remained at the bottom of the tank until 21 minutes after insertion, when it started lifting off the bottom.
At 22 minutes after insertion, what was left of the tablet appeared on the surface (FIG. 5, image C).
The tablet remained intact, and continued to diminish in size until 33 minutes. After this it broke into several small fragments (FIG. 5, image D).
While floating on the surface, particles that broke away from the core of the tablet sank back into the water column.
By 35 minutes after insertion, the tablet had dissolved completely and there was no trace of it left.

### Discussion

Upon addition to the drum, the tablet sank to the bottom of the container and started to effervesce immediately. After 10 minutes, the tablet had lost approximately half of its original weight.

The tablet started to rise to the surface after 21 minutes, by which time it had lost approximately 80% of its original weight. In practice, for control of submerged weed species, this means that the bulk of the active ingredient in this formulation is released below the surface. The balance of the active ingredient is released at the surface, which also makes it suitable for control of floating weeds. Even as it was floating on the surface, the particles breaking loose from the core slowly sank back into the water column.

The tablet dissolved completely in 35 minutes at 28° C. Since some closed aquatic systems in need of treatment with a herbicide are overgrown with weeds and may have limited sub-surface movement/currents, a dissolution time of 35 minutes can potentially allow whatever little current there is to contribute to the dispersion of the active ingredient. Conversely, a shorter dissolution time may imply that too much of the active ingredient is released near the surface; away from the target area at deeper levels.

The tablet dissolved completely and left no trace (unaided, with no agitation).

### Example 3—Control of Sagittaria platyphylla, Azolla filiculoides, Lemna minor and Floating Filamentous Algae Cladophora sp. at Belmont North, Central Coast, New South Wales (NSW) with SCAL 5174

### Overview

SCAL 5174 is Composition 1 in Table 2.

A mixture of aquatic weeds with different growth patterns including fully submerged (Cladophora sp. and Sagittaria), emergent (Sagittaria) and floating (Cladophorasp, Azolla and Duckweed) were successfully eradicated with two applications of SCAL 5174 at 400 ppb target concentration, 14 days apart. The ability to control weeds with different growth patterns with a single application type has significant practical advantage.

SCAL 5174 was demonstrated to be effective in a typical aquatic weed control situation characterised by limited circulation of the water, shaded conditions, a mixture of weed species with different growth patterns, and the presence of desirable plants and animals.

Two applications of SCAL 5174 did not demonstrate any adverse effects against non-target plants or animals.

### Introduction

Maintenance of storm water collection points is an ongoing activity for most suburban councils. Since their main purpose is to drain storm water and prevent flash flooding, councils have a responsibility to ensure they remain functional and not overgrown with weeds. In addition, because they are often situated on public land, they attract unwanted attention from local residents if not properly maintained.

Typically, these sites become populated with a variety of plants; desirable (e.g., Typha spp., which acts as a biological water filter and breeding site for water birds) or invasive, and with different growth patterns (submerged, emergent or floating)—requiring different methods of application and different herbicides for their control.

The objective of this trial was to demonstrate the efficacy of SCAL 5174, applied as a large-diameter effervescent tablet, as a means to control a variety of invasive plants with a single herbicide active ingredient and application method, without adversely affecting desirable plants and animals present in the system.

### Description of Trial Site

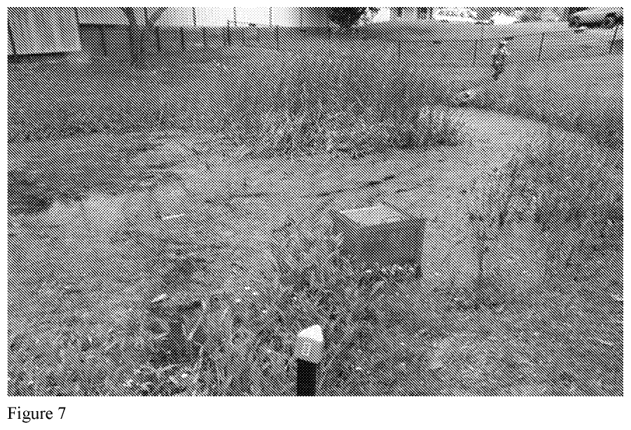

The treated area was a storm water collection pond situated in a council-owned park at Dirkala Close, Belmont North, NSW. The pond has an overflow drain, which meant that the water level remained constant regardless of inflow from the surrounding catchment. However, since there was only 17 mm of rain recorded at the site for the duration of the trial, it is assumed that very little water left the pond (FIG. 7).

The site was chosen because it contained a dense population of floating weeds consisting of a mixture of Azolla and Duckweed, as well as floating filamentous algae Cladophora sp. Although Cladophora. sp. is considered to be a floating weed, its long filaments occur throughout the water column and it could also be considered to grow fully submerged.

This combination of weeds suited the trial objective, namely to demonstrate that SCAL 5174, applied as a sub-surface treatment, is effective for controlling floating weeds growing predominantly at, or near the surface. The site also contained a population of Sagittaria, some of which was growing completely submerged, some as emergent, and a cluster growing in the mud at the edge of the water.

Given the different patterns of growth described above, the trial site provided a unique opportunity to demonstrate the efficacy of SCAL 5174 for the purpose it was designed for. SCAL 5174 is large diameter effervescent tablet containing 10% flumioxazin active ingredient. The size, dimensions, density and other attributes of the tablet were selected to create a herbicide delivery system that is able to penetrate floating weeds when thrown from the bank, sink to the bottom and release the active ingredient throughout the water column and up to the surface.

A dense cluster of Cumbungi (Typha domingensis) grew in the middle of the pond, and around the edges, with Sagittaria growing amongst it. There was also a small amount of Native Water primrose Ludwigia peploides montevidensis present in the pond.

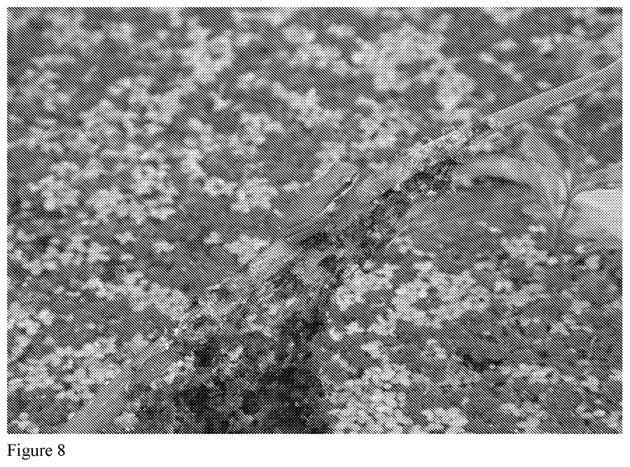

The pond also contained a large population of Eastern Dwarf Tree frogs Litoria fallax (FIG. 8), which were mostly living on the Sagittaria plants, but could also be found on the Cumbungi and other vegetation.

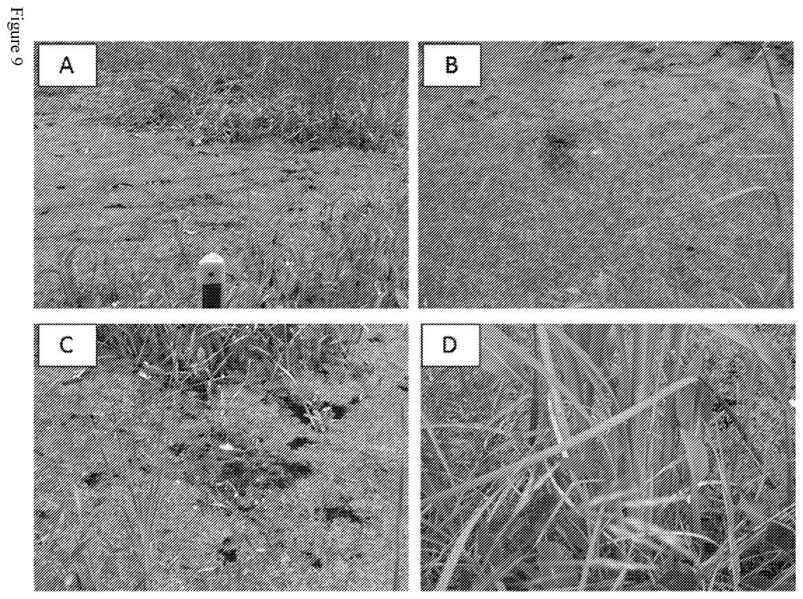

Views of the trial site before treatment can be seen in FIG. 9.

Although not evident at the time of the first application due to the large volume of surface weeds and filamentous algae present, the pond also contained a resident population of Gambusia holbrooki. These were sampled on two occasions once the bulk of floating filamentous algae was chemically removed, allowing for a sweep net to be used.

The pond was kidney-shaped, had a circumference of 50 m and an average depth of 0.688 m; calculated from 21 depth measurements. Its total surface area comprised 198.94 m², and the corresponding water volume was 136.87 m³ when the water level was flush with the top of the outflow drain.

An estimated 15% of the total surface of the pond was shaded by surrounding trees at noon.

Five permanent assessment points (replicates) were established around the perimeter of the pond, corresponding with areas of the pond where both floating weeds and Sagittaria occurred.

Pre-treatment density of the floating weeds complex (Duckweed [estimated at 5%], Azolla [15%] and floating filamentous algae [80%] which could not be separated) at the time of the first application is shown in Table 4. Each sample was taken with a floating PVC quadrant. Each sample was 0.25 m².

TABLE 4
Day 0 (27 November 2017): Floating weed complex

| | 1^{st} Replicate | 2^{nd} Replicate | 3^{rd} Replicate | 4^{th} Replicate | 5^{th} Replicate | Average |
|---|---|---|---|---|---|---|
| Wet weight/g | 218 | 167 | 377 | 234 | 157 | 230.6 |
| Dry weight/g* | 22 | 19 | 38 | 23 | 20 | 24.4 |

*After 7 days at 60° C.

Weed samples were collected using a floating PVC quadrant, by collecting the vertical weed mass within the quadrant boundaries, approximately 2 m from the edge of the water edge at five pre-determined sampling points. Total area sampled was 1.25 m².

Average wet sample weight was 230.6 g. Cumulative wet sample weight was 1153 g. Based on 198.94 m² total pond surface area, there was an estimated 183.5 kg of floating weeds present in the pond at the start of the trial.

Pre-treatment density of Sagittaria at the time of the first application is shown in Table 5.

TABLE 5
Day 0 (27 November 2017): Sagittaria platyphylla collected at
pre = determined sampling points.

| | 1^{st} Replicate | 2^{nd} Replicate | 3^{rd} Replicate | 4^{th} Replicate | 5^{th} Replicate | Average |
|---|---|---|---|---|---|---|
| Wet weight (g) | 1054 | 43 | 105 | 179 | 517 | 379.6 |
| Dry weight* | 78 | 26 | 11 | 16 | 20 | 30.2 |

*After 7 days at 60° C.

Weed samples were collected using a floating PVC quadrant, by collecting the vertical weed mass within the quadrant boundaries, approximately 1-2 m from the edge of the water at five pre-determined sampling points. Total area sampled was 1.25 m². Only Sagittaria growing in the water was sampled.

Average wet sample weight was 379.60 g. Cumulative wet sample weight was 1898 g. Because Sagittaria did not occur throughout the pond but grew in clusters, an estimate of the total mass of Sagittaria in the pond could not be accurately calculated.

### Application:

Based on the calculated volume of water to be treated (136.87 m³), 3.65 tablets were required to achieve a target concentration of 400 ppb. However, because the tablets are a certain minimum size (150 g each), this number was rounded to 4 tablets—effectively giving an initial concentration of 438 ppb at each application. Details for the 1^{st} and 2^{nd} applications are shown in Table 6.

TABLE 6
Application conditions

| | 1^{st} Application | 2^{nd} Application |
|---|---|---|
| | (27 Nov. 2017, | (11 Dec. 2017, |
| Parameter | 10:30 - Day 0) | 11:00 - Day 14) |
| pH of the water in | 6.82 | 6.50 |
| treated area | | |
| Water temperature/ | 20 | 22 |
| ° C. | | |
| Conditions | Sunny, no rain | Hot and sunny, and |
| | | remained like this for the |
| | | next three days |
| Method | 4 tablets thrown from the | 4 tablets thrown from the |
| | bank to achieve the best | bank - targeting areas with |
| | distribution of the product | most remaining Sagittaria |
| | throughout the pond | |

### Results

The sequence of events at this trial site are shown in Table 7.

TABLE 7
Trial 1 sequence of events

| Sequence | Date | Description |
|---|---|---|
| Day 0 | 27 Nov. 2017 | Pre-treatment weed sampling |
| | | 1st Application |
| Day 5 | 2 Dec. 2017 | Photographic assessment |
| Day 14 | 11 Dec. 2017 | Photographic assessment |
| | | 2nd Application |
| | | Sampling of fish |
| | | Sampling of floating weed complex |
| Day 30 | 27 Dec. 2017 | Photographic assessment |
| Day 45 | 11 Jan. 2018 | Photographic assessment |
| | | Sampling of fish |
| Day 62 | 29 Jan. 2018 | Final weed assessment |
| | | Photographic assessment |

### Day 5 (2 Dec. 2017)

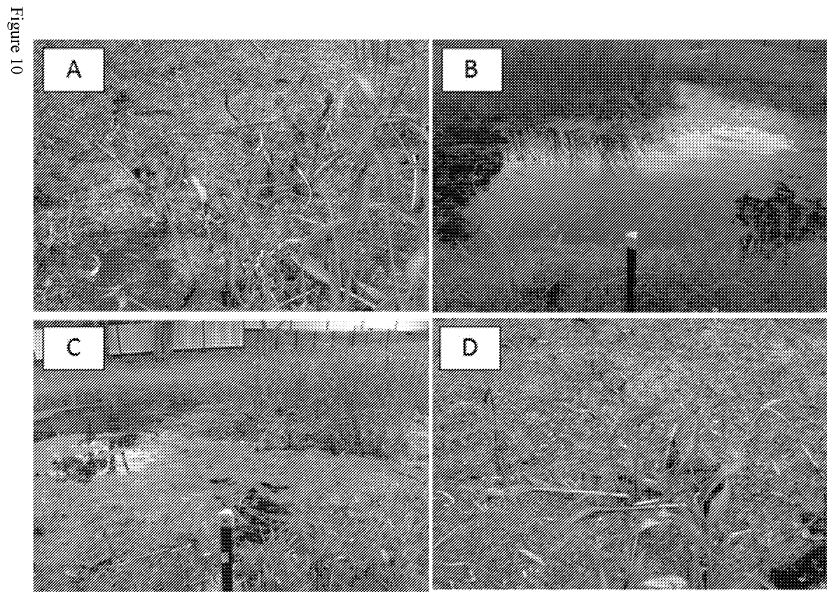

A photographic record of the pond on this date is shown in FIG. 10.

At five days after application the effect of the herbicide started to become evident. Most noticeably, there was less floating filamentous algae present in the upper layers of the pond. It was evident that, due to its large surface-to-volume ratio and vertical distribution throughout the water column, floating filamentous algae were best positioned to take up the available herbicide from the water column.

At the same time, Duckweed and Azolla floating on the surface started to turn brown and thinned out as they became affected by the herbicide—resulting in open areas on the surface of the pond.

Sagittaria growing in the water also started to show signs of yellowing, wilting and leaf necrosis.

There was no apparent reduction in the number of Eastern tree frogs, nor were there any other adverse effects observed.

### Day 14 (11 Dec. 2017)

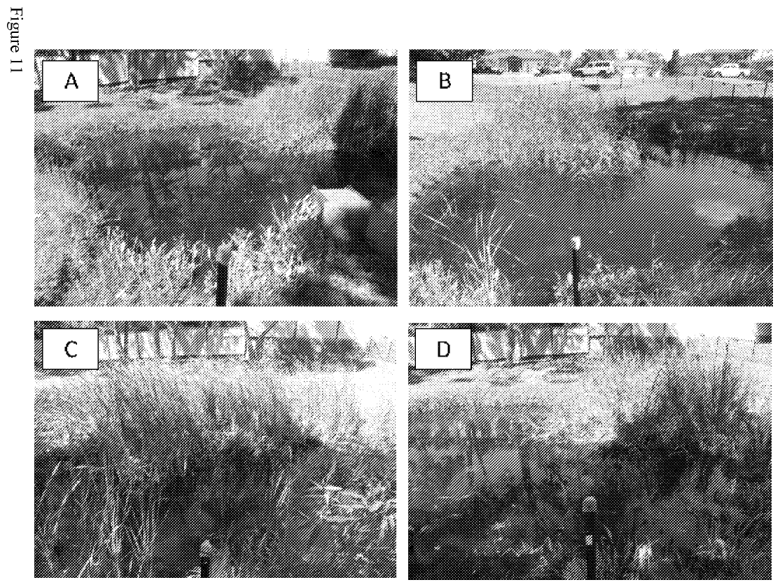

A photographic record of the pond on this date is shown in FIG. 11.

By 14 days after application most of floating weed complex had been controlled. There were no floating filamentous algae at any depth in the water column—not from sampling with a floating PVC quadrant, nor accumulating in the sweep net when sampling for fish. By this assessment date Cladophora spp. was completely eradicated from the water column.

The remaining floating weeds were sampled on this date—consisting of Azolla (˜85%) and Duckweed (˜15%). Weed samples were collected using a floating PVC quadrant (0.25 m²), by collecting the vertical weed mass within the quadrant boundaries, approximately 2 m from the edge of the water at five pre-determined sampling points. Total area sampled was 1.25 m². The results are shown in Table 8. It was not possible to separate Azolla and duckweed and the sample weights indicated below is combined weight. Estimated composition of samples were Azolla 85%/Duckweed 15%.

The corresponding percentage reduction in biomass is shown in of Floating weed complex after 14 days (dry weight) is shown in Table 9.

TABLE 8
Assessment of floating weeds complex on day 14 (sampled with a floating
PVC quadrant. Each sample was 0.25 m2).

| | 1^{st} Replicate | 2^{nd} Replicate | 3^{rd} Replicate | 4^{th} Replicate | 5^{th} Replicate | Average |
|---|---|---|---|---|---|---|
| Wet weight (g) | 1.0 | 2.5 | 2.2 | 4.4 | 1.5 | 2.32 |
| Dry weight (g)* | 0.1 | 0.17 | 0.17 | 0.38 | 0.12 | 0.188 |

*After 7 days at 60° C.

TABLE 9
Percentage reduction in biomass of Floating weed
complex after 14 days (dry weight).

| | 1^{st} Replicate | 2^{nd} Replicate | 3^{rd} Replicate | 4^{th} Replicate | 5^{th} Replicate | Average |
|---|---|---|---|---|---|---|
| Percent reduction | 99.6 | 99.2 | 99.6 | 98.4 | 99.4 | 99.2 |

At 14 days after application, the surface of the pond was mostly clear, with only small amounts of Azolla and duckweed remaining. Remaining weeds were discoloured and visibly affected by the herbicide. Below the surface, the water was completely clear—allowing for a sweep net to be used for collection of fish. Samples of Gambusia holbrooki were taken from the site.

The fish were collected with a swimming pool leaf rake at five collection points. Fish numbers recorded below were collected from a single sweep (2.5 m arc), just below the surface at a depth of 0 to 50 cm. Only one species Eastern gambusia (Gambusia holbrooki) was present (Table 10).

TABLE 10
Number of Gambusia holbrooki collected
at different sections of treatment site on day 14

| | Sample 1 | Sample 2 | Sample 3 | Sample 4 | Sample 5 |
|---|---|---|---|---|---|
| Number | 16 | 6 | 9 | 18 | 31 |
| Length | 12.9 to | 17.5 to | 11.2 to | 10.5 to | 11.0 to |
| (mm) | 38.2 | 38.5 | 34.5 | 33.3 | 42.0 |
| Average | 19.18 | 27.5 | 20.33 | 19.95 | 25.36 |
| Length | | | | | |
| (mm) | | | | | |

At 14 days after application, Sagittaria growing submerged was completely brown and decomposing. Emergent Sagittaria had turned yellow and showed symptoms of being affected by the herbicide. Overall the bulk of Sagittaria in the pond was diminished, and at this stage the majority of Eastern Dwarf Tree frogs migrated from the Sagittaria onto Cumbungi or other surrounding plants.

It was obvious that the majority of herbicide active ingredient from the first application was taken up by the large volume of Cladophora and floating weeds, and that a second application was required to control the remaining Sagittaria. Thus, for the second application on this date, positioning of the SCAL 5174 tablets were concentrated in areas where the most remaining Sagittaria occurred.

### Day 30 (27 Dec. 2017)

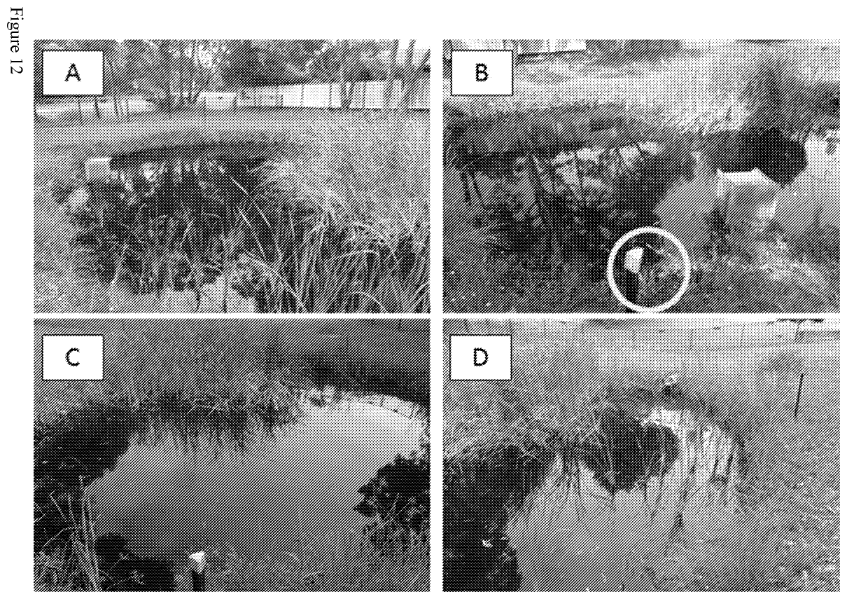

A detailed photographic record of the pond at this date is shown in FIG. 12.

30 days after the first application, and 16 days after the second application, the surface of the pond was completely clear, with no Azolla, Duckweed or Cladophora sp. present. The water was clear all the way to the bottom.

30 days after application DAA, all the Sagittaria growing in the water—submerged or emergent, had died. The only remaining Sagittaria was a single cluster of plants growing in the mud, 30 cm from the edge of the water. Even the Sagittaria growing amongst the cluster of Cumbungi in the centre of the pond was controlled (image B of FIG. 12).

Native water primrose was still present in the pond and was not affected by the treatment. In addition, two applications of SCAL 5174 did not affect Cumbungi growing in the water—even in close proximity to where SCAL 5174 tablets were applied.

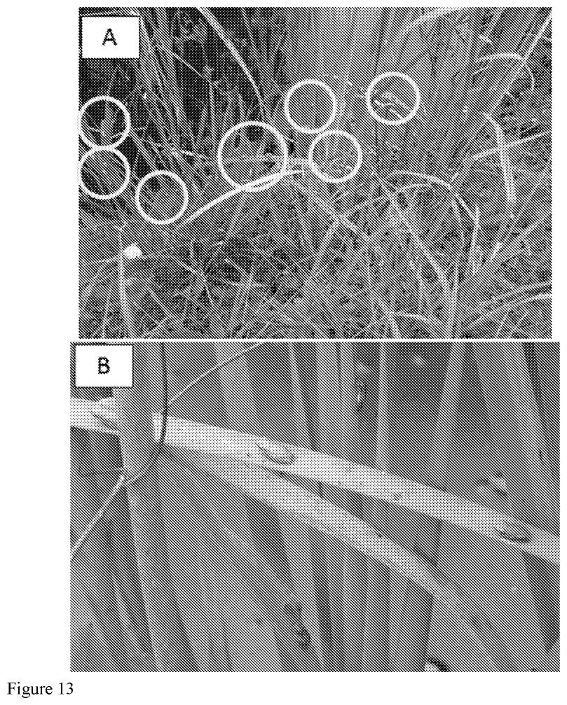

Two applications of SCAL 5174 did not affect the population of Eastern Dwarf Tree Frogs. With the demise of Sagittaria in the pond, they migrated onto Cumbungi or other vegetation (FIG. 13).

### Day 45 (11 Jan. 2018)

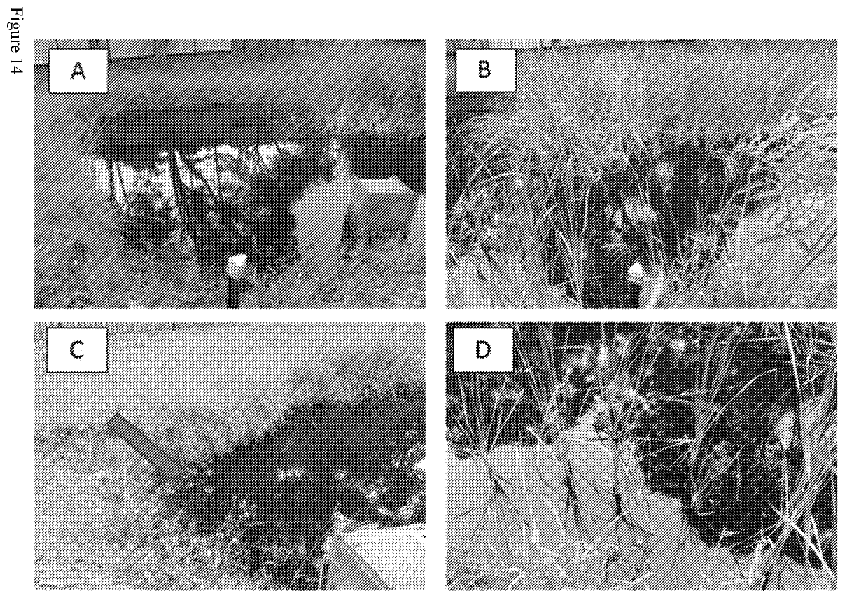

A photographic record of the pond at this date is shown in FIG. 14. The arrow in FIG. 14 shows Native Water Primrose not affected by the addition of the herbicide.

At this assessment date there were no signs of living weed below or at the surface of the pond. The only remaining weed was a cluster of Sagittaria growing clear of the water. A second sampling to quantify the fish population occurred on this day. Fish were collected with a swimming pool leaf rake at five collection points. Fish numbers recorded below were collected from a single sweep (2.5 m arc), just below the surface at a depth of 0 to 50 cm. Only one species Eastern gambusia (Gambusia holbrooki) was present. The results are shown in Table 11.

TABLE 11
Number of Gambusia holbrooki collected at different
sections of treatment site on day 45.

| | Sample 1 | Sample 2 | Sample 3 | Sample 4 | Sample 5 |
|---|---|---|---|---|---|
| Number | 37 | 35 | 42 | 48 | 36 |
| Length | 13.3 to | 12.9 to | 14.0 to | 12.9 to | 12.10 to |
| (mm) | 28.0 | 23.0 | 41.0 | 44.5 | 25.0 |
| Average | 18.48 | 16.24 | 19.64 | 18.47 | 16.25 |
| Length | | | | | |
| (mm) | | | | | |

No adverse treatment effects were observed. Non-target plants Cumbungi and native Water Primrose were growing normally, and the resident frog population appeared unchanged.

### Day 62 (29 Jan. 2018)—Final Assessment and Weed Sampling

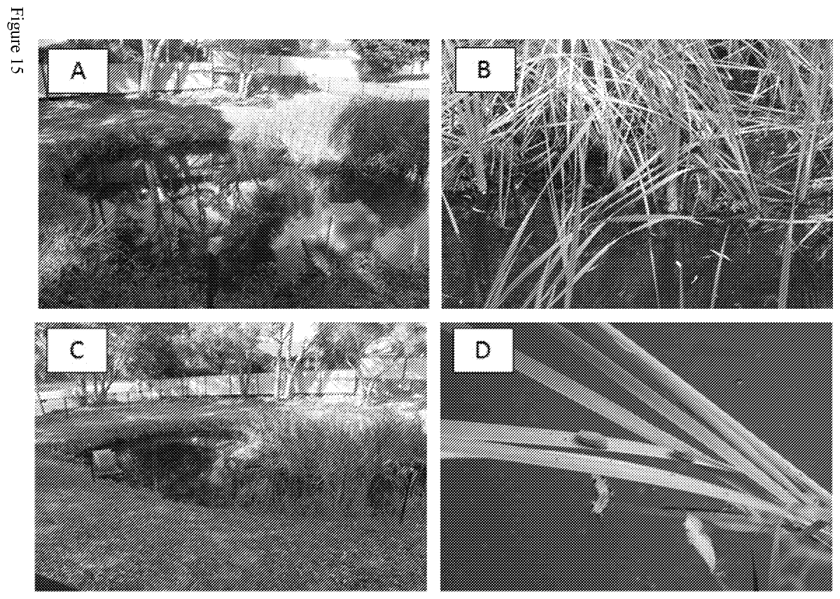

A photographic record of the pond at this date is shown in FIG. 15.

The conclusive weed assessment and sampling for Sagittaria was conducted on this date, 62 days after the initial treatment, and 48 days after the second application.

Weed samples were collected with a macrophyte sampler, approximately 2 m from the edge of the water at five pre-determined sampling points. The cutting blade on the sampler was 500 mm long, sampling 0.2 m2 at the base. Total area sampled was 1.0 m². None of the samples yielded any live Sagittaria (Table 12 and Table 13).

TABLE 12
Day 62 (29 January 2018) Sagittaria content - Sampled with
a macrophyte sampler. Each sample was 0.2 m2

| | 1^{st} Replicate | 2^{nd} Replicate | 3^{rd} Replicate | 4^{th} Replicate | 5^{th} Replicate | Average |
|---|---|---|---|---|---|---|
| Wet weight (g) | 0 | 0 | 0 | 0 | 0 | 0 |
| Dry weight* (g) | 0 | 0 | 0 | 0 | 0 | 0 |

*After 7 days at 60° C.

TABLE 13
Percentage reduction in biomass (dry weight) of Sagittaria
after two applications of SCAL 5174

| | 1^{st} Replicate | 2^{nd} Replicate | 3^{rd} Replicate | 4^{th} Replicate | 5^{th} Replicate | Average |
|---|---|---|---|---|---|---|
| Percent reduction | 100 | 100 | 100 | 100 | 100 | 100 |

At the final assessment date there were no evidence of living weed below or at the surface of the pond. The only remaining weed was a cluster of Sagittaria, growing clear of the water.

No adverse treatment effects were observed. Non-target plants Cumbungi and native Water Primrose were growing normally, and the resident fish and frog population appeared normal.

### Discussion and Conclusion

One application of SCAL 5174 (10 DT) at a target concentration of 400 ppb (actual estimated at 438 ppb) gave 99.2% reduction in biomass of the floating weed complex (Azolla filiculoides, Lemna minor and Cladophora sp.) At 62 days, after a second application, reduction in biomass of the floating weeds complex improved to 100% and none could be detected in the pond.

At 62 days after the initial treatment, and 48 days after the second treatment, two applications of SCAL 5174 fourteen days apart gave 100% reduction in biomass of all Sagittaria growing fully submerged, or emergent in the water. The only remaining Sagittaria was growing outside of the water and had no exposure to the herbicide.

### Effect on Other Non-Target Plants and Organisms

At the effective rate, SCAL 5174 had no permanent effect on non-target vegetation. Some Cumbungi growing in the water displayed transient symptoms including browning at the surface of the water but continued to grow normally. Others, noticeably younger plants, did not display any symptoms at all. The small amount of Native Water Primrose present at the start of the trial was still there at the final assessment and was growing normally.

Application of SCAL 5174 did not affect vegetation on the surrounding banks.

There was no apparent decline in frog numbers or activity during the trial period. Despite the removal of their preferred hostplant Sagittaria, Eastern Dwarf tree frogs remained active at the site up to the final assessment, with no noticeable change in their behaviour. Once Sagittaria was controlled they migrated to Cumbungi and other vegetation.

Fish were sampled at two dates; 14 days after the first application, and 30 days after the second application. Due to the large amount of filamentous algae present at the start, it simply wasn't possible to sample fish at the onset of the trial. At the first sampling date, the average number Gambusia holbrooki collected was 16 per sample, with an average length of 22.46 mm.

30 Days after the second application, the average number of fish more than doubled to 39.6 per sample, but the average length decreased to 17.81 mm. These numbers suggest an increase in breeding activity but the reason for this requires more research. However, a logical conclusion from these numbers is that application of SCAL 5174 to the pond did not reduce fish numbers or inhibit breeding.

An inevitable consequence of chemical control is decline in water quality as the weeds start to die and decompose. With SCAL 5174 however, this was a gradual process and at no point did the water quality decline to levels where fish kills occurred. After 62 days and two applications of SCAL 5174, the pond was returned to its natural state and left in a much healthier general condition compared to before.

### Herbicidal Efficacy of SCAL 5174

There was hardly any water movement in this pond to assist with the dispersion of herbicide active ingredient. Also, because the pond was relatively shallow, it only required four SCAL 5174 tablets to treat the entire area at the target concentration.

Yet, despite these limitations, SCAL 5174 dispersed to all areas of the pond—as illustrated by the eradication of Azolla and Duckweed in all areas, and the removal of Cladophora algae in all areas. This ability is related to the design and composition of SCAL 5174 tablets in which an effervescent propellant disperses the active ingredient upwards through the water column. As it releases from a static point on the bottom of the pond, the plume of liberated material spreads out to a much larger area at the surface. This is where surface currents caused by air movement aids with dispersing the active ingredient. In addition, as it moves upwards through the water column, whatever little movement there is in the pond.

### Example 4—Trial 2: Control of Water Stargrass Heteranthera zosterifolia at Bonnells Bay, NSW Central Coast with SCAL 5174

### Overview

SCAL 5174 is Composition 1 in Table 2.

A very dense infestation of Water Stargrass Heteranthera zosterifolia was successfully eradicated with three applications of SCAL 5174 at 400 ppb target concentration, 14 to 16 days apart.

SCAL 5174 was demonstrated to be effective in a worst-case aquatic weed control situation characterised by very dense growth, limited circulation of the water, and shaded conditions.

### Introduction

Heteranthera zosterifolia is a perennial aquatic plant that forms dense mats in shallow water. It is considered to be an emerging threat to wetlands and waterways. Prior to its discovery at this trial site, the first and only known occurrence of it becoming established outside of cultivation was in December 2011, when a single infestation was recorded in the Port Macquarie district.

Water Stargrass plants are usually rooted in the mud and grows upwards towards the water surface. It is capable of growing completely submerged, or above the water. At this trial site, it was well-established and occupied the entire water column with very dense growth above and below the surface.

Given the pattern of growth described above, the trial site provided a unique opportunity to demonstrate the efficacy of SCAL 5174 for the purpose it was designed for. SCAL 5174 was utilised in the form of a large diameter effervescent tablet containing 10% flumioxazin as an active ingredient (FIG. 1, FIG. 2 and FIG. 3). The size, dimensions, density and other attributes of the tablet were selected to create a herbicide delivery system that is able to penetrate dense mats of weeds when thrown from the bank, sink to the bottom and release the active ingredient throughout the water column and up to the surface.

An adjacent pond, also infested with Water Stargrass but also Salvinia molesta and anchored filamentous algae (Chara sp.) provided a further opportunity to demonstrate bioequivalence between SCAL 5174 (10% DT flumioxazin) and SCAL 5145 (75% WG flumioxazin) for control of H. zosterifolia.

### Description of Trial Site

The treated area was an isolated storm water collection pond situated in the grounds of Lakeside Retirement Village, Bonnells Bay, NSW Central Coast, Australia. It is the last (and lowest) of four collection ponds, and because only light rainfall occurred at the site for the duration of the trial, it remained completely isolated with no inflow from the higher lying ponds.

At the time of application, Water Stargrass was the dominant weed in the pond. However, at subsequent assessment dates once the Water Stargrass had become affected by SCAL 5174, it became obvious that there was a substantial amount of floating filamentous algae (Pithophora sp) entrapped in the Water Stargrass that wasn't distinguishable prior to application of SCAL 5174 due to the density of the dominant weed.

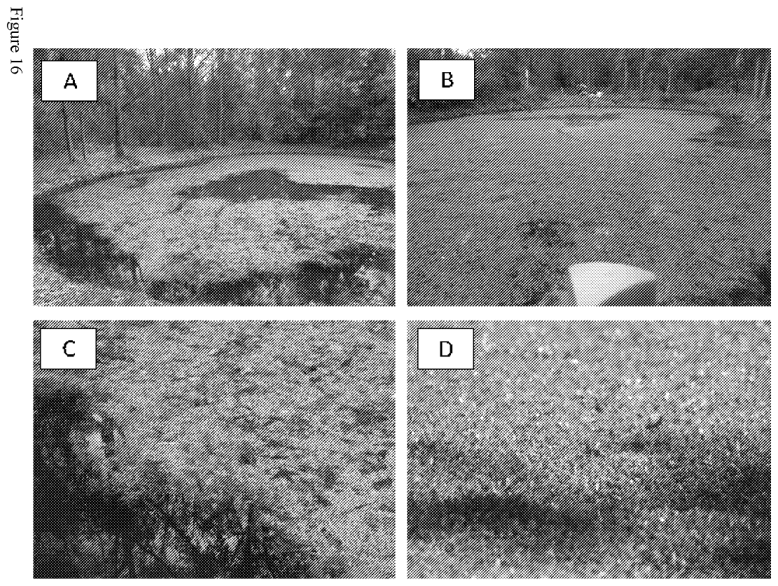

A photographic record of the trial site before treatment is shown in FIG. 16.

The pond was circular in shape, had a circumference of 63.8 m, with a surface area of 323.91 m², and an average depth of 0.63 m calculated from 12 individual depth measurements across four horizontal transects. Based on the above measurements, the volume of water contained at the time of application was 204.06 m³.

An estimated 30% of the total surface of the pond was shaded by surrounding trees at noon. Other than large numbers of small fish (identified as Gambusia holbrooki) and evidence of migratory ducks, there were no signs of animal life in the pond. Due to the extreme thick nature of the primary weed, sampling of fish numbers before chemical treatment was not possible. However, once the weeds became affected by the herbicide and the pond surface cleared, it became apparent that the pond also supported a small population of exotic carp.

Five permanent assessment points (replicates) were established around the perimeter of the pond. Of these, two were in areas of the pond that was shaded for most part of the day.

Water level in the pond remained fairly constant, with only 28 mm of rain recorded at the site over the duration of the trial.

The pre-treatment density of Heteranthera zosterifolia at the time of the first application is shown in Table 14.

TABLE 14
The pre-treatment density of Heteranthera zosterifolia at the time
of the first application (sampled with a floating PVC
quadrant. Each sample was 0.25 m2).

| | 1^{st} Replicate | 2^{nd} Replicate | 3^{rd} Replicate | 4^{th} Replicate | 5^{th} Replicate | Average |
|---|---|---|---|---|---|---|
| Wet weight/g | 2689 g | 1335 | 1368 | 2261 | 3322 | 2195 |
| Dry weight*/g | 144 g | 170 g | 129 g | 190 g | 295 g | |

*After 7 days at 60° C.

Weed samples were collected using a floating PVC quadrant, by collecting the vertical weed mass within the quadrant boundaries, approximately 2-3 m from the edge of the water at five pre-determined sampling points. Total area sampled was 1.25 m².

Average wet sample weight was 2195 grams. Cumulative wet sample weight was 10 975 grams. Based on 323.91 m² total pond surface area, there was an estimated 2844 kg of Water Stargrass present in the pond at the start of the trial.

### Application

Based on the calculated volume of water to be treated (204.06 m³), 5.44 tablets were required to achieve a target concentration of 400 ppb. However, because the tablets are a certain minimum size, this number was rounded to six tablets—effectively giving an initial concentration of 441 ppb at each application. The application parameters are shown in Table 15.

TABLE 15
Application conditions for Trial 2

| | 1^{st} Application | 2^{nd} Application | 3^{rd} Application |
|---|---|---|---|
| | (27 Nov. 2017, | (11 Dec. 2017, | (27 Dec. 2017, |
| Parameter | 09:00 - Day 0) | 11:00 - Day 14) | 11:00 - Day 30) |
| pH of the | 6.18 | 6.1 | 6.5 |
| water in | | | |
| treated area | | | |
| Water | 19.6 | 20 | 23 |
| temperature / | | | |
| C. | | | |
| Conditions | Sunny, no rain | Hot and sunny, and | Hot and sunny |
| | | remained like this | |
| | | for the next three | |
| | | days | |
| Method | 6 tablets thrown | 6 tablets thrown | 6 tablets thrown |
| | from the bank | from the bank. Four | from the bank. |
| | into six areas of | tablets into shaded | Positioned in areas |
| | the pond where | area of the pond, | where there was the |
| | the weed | and two into the | most vegetative |
| | appeared to be | open section where | growth below the |
| | thickest, | the growth was the | surface |
| | approximately | thickest | |
| | 10 m apart | | |

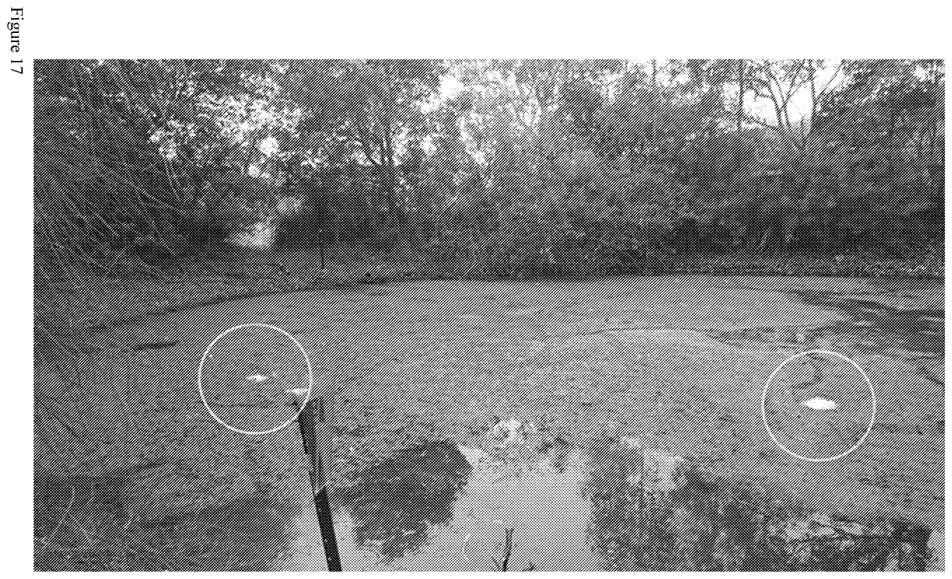

Superficial signs of where the tablets entered the weed mass with the 1^{st} application is shown in FIG. 17.

### Results

The sequence of events at the trial site are shown in Table 16.

TABLE 16
The sequence of events for Trial 2

| Sequence | Date | Description |
|---|---|---|
| Day 0 | 27 Nov. 2017 | Pre-treatment weed sampling |
| | | 1^{st} Application |
| Day 5 | 2 Dec. 2017 | Photographic assessment |
| Day 14, | 11 Dec. 2017 | Photographic assessment |
| | | 2^{nd} Application |
| Day 30 | 27 Dec. 2017 | Photographic assessment |
| | | 3^{rd} Application |
| Day 45 | 11 Jan. 2018 | Photographic assessment |
| Day 71 | 7 Feb. 2018 | Final weed sampling |
| | | Photographic assessment |

### Day 5 (2 Dec. 2017)

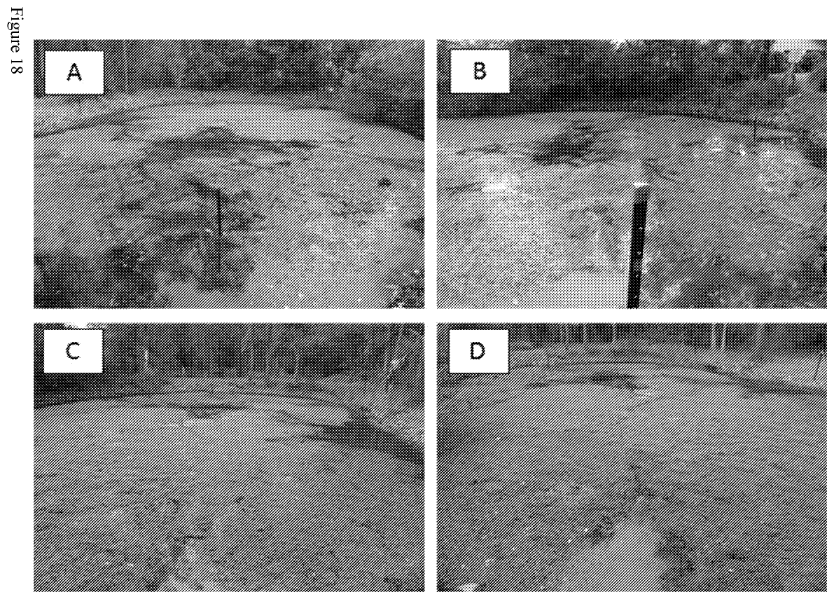

A photographic record of the pond on this date is shown in FIG. 18.

At five days after application the effect of the herbicide started to become evident, particularly in the unshaded section of the pond. Initial symptoms were browning of the weed and lack of turgescency—causing the weed mass to appear less dense and sink below the surface.

### Day 14 (11 Dec. 2017)

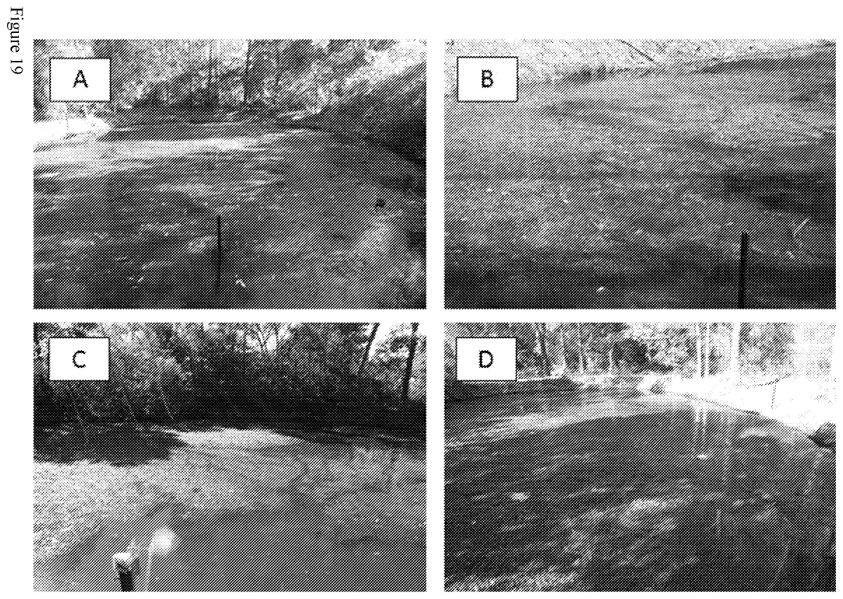

A photographic record of the pond on this date is shown in FIG. 19.

Fourteen days after application most of the Water Stargrass in the unshaded section of the pond had sunk below the surface and changed colour from green to brown, with limited amounts of vegetative growth visible at the surface. Large areas of pond surface had cleared, through which the decomposing weed at the bottom could be observed.

Patches of floating filamentous algae (Pithophora sp.) affected by the herbicide appeared on the surface as it became dislodged from the decomposing weed mass.

In the shaded parts of the pond the weed was generally less turgescent, less dense at the surface and hanging deeper in the water, with some discoloration setting in but still generally green.

A second application of SCAL 5174 occurred on this date (six tablets)—of which four were positioned into shaded parts of the pond and the remaining in the clear area.

### Day 30 (27 Dec. 2017)

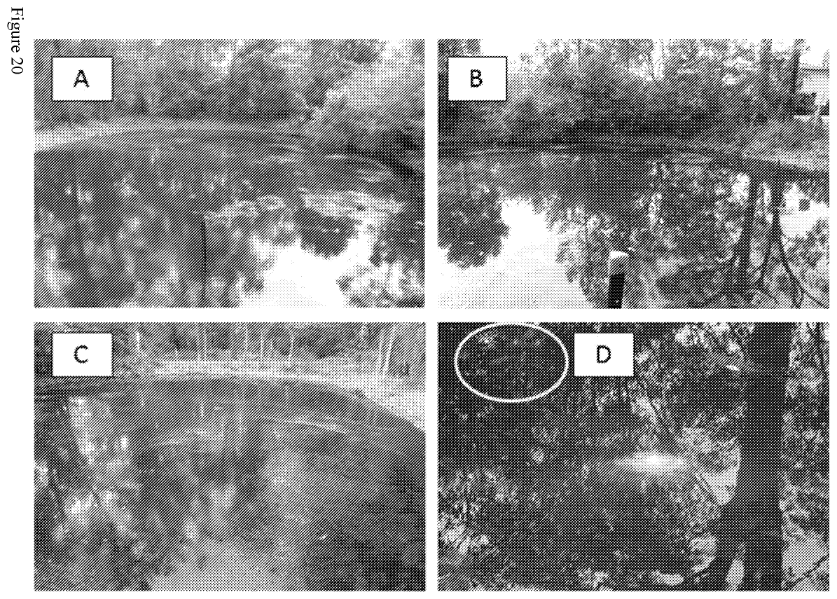

A photographic record of the pond at this date is shown in FIG. 20.

Thirty days after the first application, and 16 days after the second application, 90% of the Water Stargrass in the pond had died and was no longer visible at the surface. Only in the shaded parts of the pond could small amounts of green growth be found.

By this date, the majority of the pond surface was clear, and the top 45 cm free of weeds. The water was clear with visibility all the way to the bottom. The bulk of the Water Stargrass was dying or decomposing. Also, at this date, it became apparent that the pond was home to a population of exotic carp (FIG. 20, image D).

A third and final application of SCAL 5174 occurred on this date to ensure that the last remaining bits of green Water Stargrass in the shaded areas would be controlled. Six tablets were applied—three into the shaded section where the most sub-surface vegetative growth occurred, and three to the remaining sections of the pond.

### Day 45 (11 Jan. 2018)

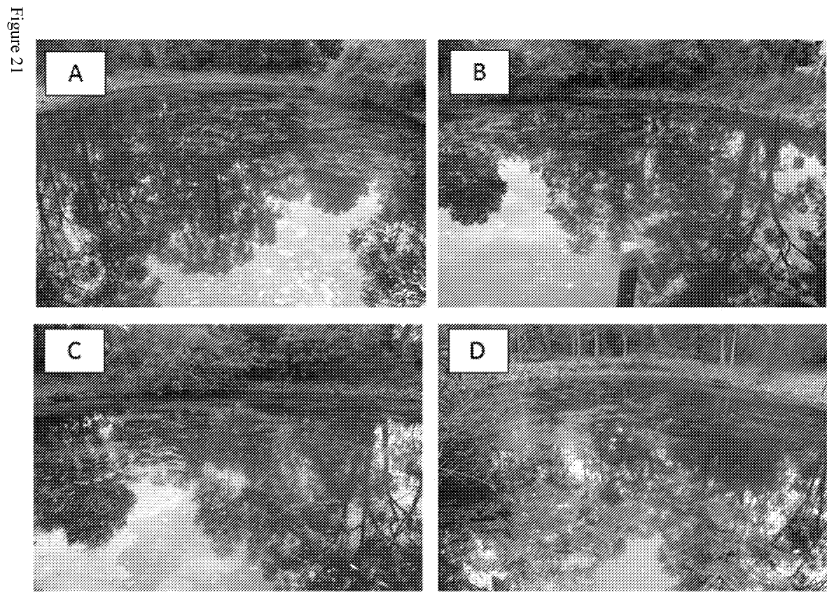

A photographic record of the pond at this date is shown in FIG. 21.

At this assessment date there were no signs of living weed below or at the surface of the pond. All of the Water Stargrass had sunk and was either dying or decomposed. There were patches of rotting Pithophora algae floating on the surface of the water.

### Day 71 (7 Feb. 2018). Final Assessment and Weed Sampling

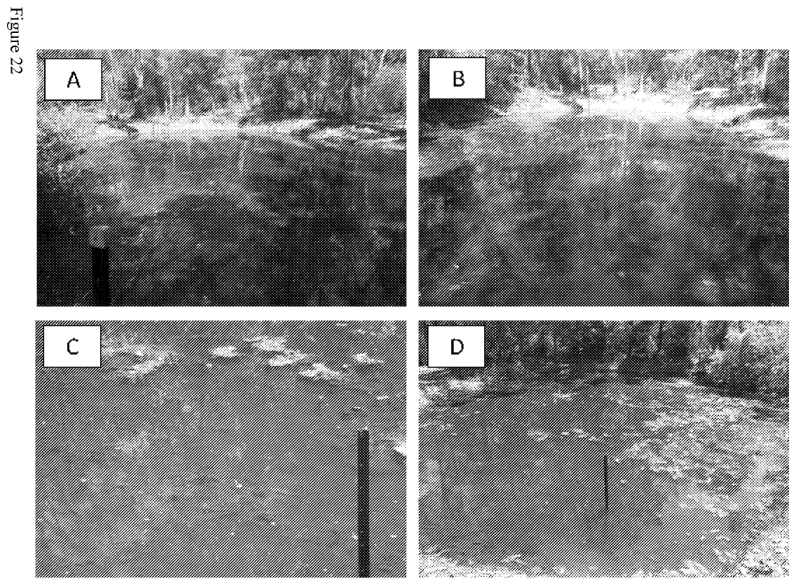

A photographic record of the pond at this date is shown in FIG. 22.

The conclusive weed assessment and sampling was conducted on this date, 71 days after the initial treatment, and after two additional applications at 14 and 30 days respectively.

At this timing, there were no signs or Water Stargrass in the pond. The water was clear all the way to the bottom and the only remaining vegetation were patches of filamentous algae floating on the surface. These were a mixture of dead and re-growing Pithophora filamentous algae.

Weed samples were collected with a macrophyte sampler, approximately 2-3 m from the edge of the water at five pre-determined sampling points. The cutting blade on the sampler was 500 mm long, sampling 0.2 m² at the base. Total area sampled was 1.0 m². The results are shown in Table 17.

TABLE 17
Measuring the quantity of Water Stargrass on Day 71 (sampled with a
macrophyte sampler. Each sample was 0.2 m2).

| | 1^{st} Replicate | 2^{nd} Replicate | 3^{rd} Replicate | 4^{th} Replicate | 5^{th} Replicate | Average |
|---|---|---|---|---|---|---|
| Wet weight | 0 g | 0 g | 0 g | 0 g | 0 g | 0 g |
| Dry weight* | 0 g | 0 g | 0 g | 0 g | 0 g | 0 g |

*After 7 days at 60° C.

None of the macrophyte samples returned any live Water Stargrass. Only dead branches, leaves and slimy decomposed matter could be retrieved.

### Effect on Other Non-Target Plants and Organisms

The sheer volume of invasive weed in the pond meant that it was already environmentally compromised and limiting from a biodiversity perspective. Other than Gambusia holbrooki which could not be sampled due to the density of the weed, and evidence of ducks visiting the pond, there were no other animal life to be considered at the start of the trial.

By the end of the trial, after three applications of SCAL 5174 at 2-3 week intervals, Gambusia holbrooki was still present in the pond, as well as a population of exotic carp that was previously obscured by the weed mass.

Application of SCAL 5174 did not affect vegetation on the surrounding banks.

### Discussion and Conclusion

SCAL 5174 (10 DT), applied three times at a target concentration of 400 ppb (actual estimated at 441 ppb in this trial) gave complete eradication of H. zosterifolia. Three applications, 2-3 weeks apart, were required to achieve complete control.

At this rate, SCAL 5174 had no effect on the surrounding vegetation, nor did it affect resident populations of Gambusia, tadpoles and exotic carp, despite a significant deterioration in water quality caused by the large amount of decomposing vegetation in the pond. No adverse environmental effects were observed for the duration of the trial.

Given flumioxazin's dependency on sunlight to work effectively, this trial was a severe test for SCAL 5174. Not only were large areas of the pond shaded, there was also very little movement in the water to assist the dispersion of herbicide active ingredient due to the very dense nature of the weed.

Application of six tablets to 323 m² of surface area, or 204 m³ of water, meant that each tablet effectively treated 53 m² or 34 m³ of water respectively.

In addition, a substantial portion of the available active ingredient from the first application was taken up by Pithophora filamentous algae trapped amongst the Water Stargrass—as was evident from large patches of dead algae rising to the surface once the primary target weed started to sink and die.

Landowners confronted with an invasive weed situation like this have two options: (a) mechanical removal of the weed, or (b) chemical control. It is understood that any aquatic ecosystem contaminated with this amount of invasive exotic weed is already severely compromised, and regardless of which method is used to remove the weed, a temporary disruption of water quality is inevitable when remediating the pond to its natural state.

Mechanical control is effective for short term removal, but since it breaks up and seldom removes all of the weed fragments the potential for regrowth and re-establishment is high—particularly with a weed like H. zosterifolia which is capable of forming roots at every vegetative node. Since mechanical removal of weed requires the use of disruptive heavy machinery, its effect on water quality in the pond can be environmentally detrimental.

Similarly, an inevitable consequence of chemical control is decline in water quality as the weeds start to die and decompose. With SCAL 5174 however, this was a gradual process and at no point did the water quality decline to levels where fish kills occurred. After 71 days and three applications of SCAL 5174, the pond was returned to its natural state and left in a much healthier general condition compared to before.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A herbicide composition which controls at least one of submerged, emergent and floating plants, in or on a body of water, the herbicide composition comprising:
one or more protoporphyrinogen oxidase inhibitors;
an effervescent agent to disperse the one or more protoporphyrinogen oxidase inhibitors upon contact of the herbicide composition with the body of water; and
optionally one or more excipients,
wherein the herbicide composition is formulated to disperse the one or more protoporphyrinogen oxidase inhibitors:
in a first stage below the surface of the body of water; and
in a second stage at or substantially at the surface of the body of water.

2. The herbicide composition of claim 1, wherein the one or more protoporphyrinogen oxidase inhibitors are selected from the group consisting of: acifluorfen, azafenidin, bifenox, butafenacil, carfentrazone-ethyl, flufenpyr-ethyl, flumiclorac, flumiclorac-pentyl, flumioxazin, fluoroglycofen, fluthiacet-methyl, fomesafen, lactofen, oxadiargyl, oxadiazon, oxyfluorfen, pyraflufen-ethyl, saflufenacil and sulfentrazone, salts and esters thereof, and mixtures thereof.

3. The herbicide composition according to claim 1, wherein the herbicide composition is formulated to disperse the one or more protoporphyrinogen oxidase inhibitors in a substantially vertical column in the first stage, such that the one or more protoporphyrinogen oxidase inhibitors are capable of contacting at least a portion of at least one of the submerged, emergent or floating plants.

4.-7. (canceled)

8. The herbicide composition according to claim 1, wherein the effervescent agent comprises a combination of an acid component and a base component, wherein:
the acid component comprises a compound selected from the group consisting of: adipic acid, ascorbic acid, benzoic acid, citric acid, fumaric acid, glutaric acid, lactic acid, lauric acid, malic acid, maleic acid, malonic acid, oxalic acid, phthalic acid, sorbic acid, succinic acid, tartaric acid, ammonium phosphate, potassium bitartrate, potassium phosphate, dipotassium phosphate, disodium pyrophosphate, sodium acid pyrophosphate, sodium phosphate, disodium phosphate, and mixtures thereof; and
the base component comprises a compound selected from the group consisting of: a bicarbonate, a carbonate, alkali metal bicarbonates, alkaline earth metal bicarbonates, organic bicarbonates, alkali metal carbonates, alkaline earth metal carbonates, organic carbonates, alkali metal sesquicarbonates, alkaline earth metal sesquicarbonates, organic sesquicarbonates, ammonium bicarbonate, calcium bicarbonate, lithium bicarbonate, magnesium bicarbonate, potassium bicarbonate, sodium bicarbonate, arginine carbonate, ammonium carbonate, calcium carbonate, lysine carbonate, potassium magnesium carbonate, sodium carbonate, sodium glycine carbonate, sodium sesquicarbonate, zinc carbonate, and mixtures thereof.

9.-14. (canceled)

15. The herbicide composition according to claim 1, wherein the herbicide composition is formulated to disperse the one or more protoporphyrinogen oxidase inhibitors:
in the first stage for at least ten minutes below the surface of the body of water to control submerged weeds and algae, as well as the submerged portion of emergent weeds; and
then in the second stage at or substantially at the surface of the body of water to simultaneously control floating weed.

16. (canceled)

17. The herbicide composition according to claim 1, wherein the e herbicide composition comprises flumioxazin.

18. The herbicide composition according to claim 1, wherein the herbicide composition is formulated such that the final dilution level of the one or more protoporphyrinogen oxidase inhibitors in the body of water is in a range of:
5 parts-per-billion to 600 parts-per-billion;
200 parts-per-billion to 400 parts-per-billion; or
at least 400 parts-per-billion.

19.-20. (canceled)

21. The herbicide composition according to claim 1, wherein the herbicide composition is in the form of a tablet.

22.-24. (canceled)

25. The herbicide composition according to claim 1, wherein the herbicide composition comprises one or more excipients selected from the group consisting of: a dye, a marker, a pigment, a lubricant, a glidant, an anti-adherent solid carriers or fillers, surfactants, dispersants, emulsifiers, adjuvants, solubilizers, penetration enhancers, protective colloids, adhesion agents, thickeners, compatibilizers, anti-freezing agents, binders, and mixtures thereof.

26. (canceled)

27. The herbicide composition according to claim 1, wherein the herbicide composition is encapsulated in a water-soluble film or a water-soluble coating.

28.-32. (canceled)

33. The herbicide composition according to claim 27, wherein the water-soluble film or water-soluble coating dissolves within 5 minutes of the herbicide composition contacting the body of water.

34. The herbicide composition according to claim 1, wherein the herbicide composition further comprises at least one of: an insecticide, an algaecide, a bactericide, a fungicide, or a combination thereof.

35.-40. (canceled)

41. The herbicide composition according to claim 1, wherein the herbicide composition controls submerged, emergent and floating plants in or on the body of water.

42.-45. (canceled)

46. A method for controlling at least one of submerged, emergent and floating plants in or on a body of water, the method comprising a step of introducing a herbicide composition comprising:
one or more protoporphyrinogen oxidase inhibitors;
an effervescent agent to disperse the one or more protoporphyrinogen oxidase inhibitors upon contact of the herbicide composition with the body of water; and
optionally one or more excipients,
wherein the herbicide composition disperses the one or more protoporphyrinogen oxidase inhibitors:
in a first stage below the surface of the body of water; and
in a second stage at or substantially at the surface of the body of water.

47. The method according to claim 46, wherein the herbicide composition is formulated such that following introduction to the body of water, the herbicide composition disintegrates and one or more protoporphyrinogen oxidase inhibitors is dispersed to contact at least a portion of at least one of the submerged, emergent and floating plants.

48. The method according to claim 46, wherein in the one or more protoporphyrinogen oxidase inhibitors is flumioxazin.

49. The method according to claim 46, wherein the herbicide composition is in the form of a tablet.

50.-51. (canceled)

52. The method according to claim 49 wherein the tablet is dissolved in a composition comprising water and the resulting aqueous product is dispersed over the at least one of the submerged, emergent and floating plants.

53.-54. (canceled)

55. The method according to claim 46, wherein the herbicide composition controls submerged, emergent and floating plants in or on the body of water.

56. The method according to claim 46, wherein at least one of the submerged, emergent and floating plants are selected from the group consisting of: Alternanthera philoxeroides, Azolla spp., Cabomba caroliniana, Ceratophyllum Demersum, Cladophora spp., Egeria densa, Hereranthera Zosterifolia, Hydrilla Verticillicata, Hydrocotyle spp., Hygrophila polysperma, Ipomoea Aquatica, Lemna spp., Limnobium spp., Macaya fluviatilis, Najas guadalupensis, Nymphaea spp., Persicaria decipiens, Pistia stratoites, Pitophora spp., Potamogeton crispus, Potamogeton pectinatus, Potamogeton diver sifolius, Potamogeton spp., Sagittaria spp., Salivinia spp., Wolffia spp., Myriophyllum, spicatum and Mysiophyllum heterophyllum, and mixtures thereof.

57.-76. (canceled)
